(19) United States
(12) Patent Application Publication
(10) Pub. No.: US 2025/0380150 A1
(43) Pub. Date: Dec. 11, 2025

(54) DATA RECEPTION METHOD, DATA TRANSMISSION METHOD AND APPARATUSES THEREOF

(71) Applicant: FUJITSU LIMITED, Kawasaki-shi (JP)

(72) Inventors: Jian ZHANG, Beijing (CN); Yosuke AKIMOTO, Ichihara (JP); Meiyi JIA, Beijing (CN); Gang SUN, Beijing (CN)

(73) Assignee: FUJITSU LIMITED, Kawasaki-shi (JP)

(21) Appl. No.: 19/301,111

(22) Filed: Aug. 15, 2025

Related U.S. Application Data
(63) Continuation of application No. PCT/CN2023/076569, filed on Feb. 16, 2023.

(51) Int. Cl. H04W 16/28; H04W 36/00; H04W 36/08; H04W 80/02

(52) U.S. Cl. CPC H04W 16/28; H04W 36/0072; H04W 36/08; H04W 80/02

(57) ABSTRACT

A data reception apparatus, configured in a terminal equipment, includes: a receiver configured to: receive first indication information, the first indication information indicating a transmission configuration indication (TCI) state set for each candidate cell and including information of a unified TCI state type (unified TCI-StateType) for each candidate cell, receive second indication information, the second indication information indicating that the terminal equipment is switched to a target cell which is one of at least one candidate cell configured for the terminal equipment, and receive third indication information, the third indication information indicating a transmission configuration indication (TCI) state that is applied to a first bandwidth part (BWP) of the target cell from the transmission configuration indication (TCI) state set of the target cell and processor circuitry configured to perform a process to switch to the target cell according to the second indication information.

### CROSS-REFERENCE TO RELATED APPLICATION

This application is a continuation application under 35 U.S.C. 111 (a) of International Patent Application PCT/CN2023/076569 filed on Feb. 16, 2023, and designated the U.S., the entire contents of which are incorporated herein by reference.

### TECHNICAL FIELD

This disclosure relates to the field of communication technologies.

### BACKGROUND

Inter-cell beam management (ICBM) has been standardized in Rel-17 by the 3GPP Standardization Organization. The ICBM includes measurement, reporting and beam indication. For example, for the measurement, a terminal equipment is able to perform layer 1 reference signal receiving power (L1-RSRP) measurement based on synchronization signal blocks (SSBs) and physical broadcast channel (PBCH) blocks of a non-serving cell. For example, for the reporting, the terminal equipment reports an L1-RSRP measurement result to a network device. For example, for the beam indication, the network device may indicate a transmission configuration indication (TCI) state associated with a non-serving cell to the terminal equipment. In this mode, the terminal equipment may use beams of the non-serving cell, such as transmitting information to the non-serving cell or receiving information from the non-serving cell by using the beams. Although the terminal equipment may use the beams of the non-serving cell, a serving cell of the terminal equipment does not change, that is, the terminal equipment will not be switched to a non-serving cell. Hence, the terminal equipment is still within a bandwidth of the serving cell, and based on relevant configuration of the serving cell, applies an indicated TCI state associated with the non-serving cell on the serving cell. Here, the non-serving cell refers to a cell with a physical cell identifier (PCI) different from that of the serving cell.

A unified transmission configuration indication (TCI) is standardized in Release 17 (Rel-17), wherein the unified TCI in Rel-17 is mainly designed for a scenario of single transmission and reception point (sTRP).

With the progress of standardization, multiple transmission and reception points (mTRP) have become an important scenario for 5G NR systems. With transmission based on mTRP, a purpose of improving throughput or reliability may be achieved.

In previous standardization works, transmission of physical downlink shared channels (PDSCHs) based on mTRP has been standardized in Rel 16; and in Rel-17, transmission of physical downlink control channels (PDCCHs), physical uplink shared channels (PUSCHs) and physical uplink control channels (PUCCHs) based on mTRP is standardized, wherein the mTRP transmission includes mTRP transmission based on single DCI (downlink control information) (sDCI) and mTRP transmission based on multiple DCI (mDCI).

It should be noted that the above description of the background is merely provided for clear and complete explanation of this disclosure and for easy understanding by those skilled in the art.

And it should not be understood that the above technical solution is known to those skilled in the art as it is described in the background of this disclosure.

### SUMMARY

Release 18 (Rel-18) will investigate layer 1/layer 2 triggered mobility (LTM). For the Rel-18 LTM, the aim is to reduce the time needed in handover interruption via cell switch based on layer 1/layer 2 signaling, thereby enabling faster switch from the serving cell to a target cell. The target cell is a cell after switch, which may be a serving cell, or may be a non-serving cell. The handover interruption refers to a time from the terminal equipment receives a cell switch command to the terminal equipment and the cell after switch perform uplink or downlink communication for the first time.

However, it was found by the inventors that how to indicate a TCI state for a target cell in Rel-18 LTM is still a problem that needs to be solved,

In order to solve at least one of the above problems, embodiments of this disclosure provide a data reception method, a data transmission method and apparatuses thereof. Hence, a terminal equipment is able to quickly apply a suitable TCI state after cell switch, thereby reducing handover interruption times.

According to one aspect of the embodiments of this disclosure, there is provided a data reception method, applicable to a terminal equipment, the method including:
receiving first indication information, the first indication information indicating at least one transmission configuration indication (TCI) state set;
receiving second indication information, the second indication information indicating that the terminal equipment is switched to at least one target cell; and
receiving third indication information, wherein for a target cell, the third indication information indicates a TCI state that is applied to a first BWP of the target cell from a first TCI state set, and wherein the first TCI state set is one of the TCI state set indicated by the first indication information.

According to another aspect of the embodiments of this disclosure, there is provided a data reception method, applicable to a terminal equipment, the method including:
receiving fourth indication information, the fourth indication information indicating at least one TCI state set;
receiving fifth indication information, the fifth indication information indicating at least one TCI state subset, wherein for a TCI state set, the fifth indication information indicates a TCI state subset in the TCI state set;
receiving sixth indication information, the sixth indication information indicating that the terminal equipment is switched to at least one target cell, wherein a target cell is one of candidate cells configured for the terminal equipment; and
receiving seventh indication information, wherein for a target cell, the seventh indication information indicates a TCI state from a second TCI state set that is applied to a third BWP of the target cell, and wherein the second TCI state set is one of the TCI state subset indicated by the fifth indication information.

According to a further aspect of the embodiments of this disclosure, there is provided a data transmission method, applicable to a network device, the method including:
transmitting first indication information, the first indication information indicating at least one TCI state set;
transmitting second indication information, the second indication information indicating that a terminal equipment is switched to at least one target cell; and
transmitting third indication information, wherein for a target cell, the third indication information indicates a TCI state that is applied to a first BWP of the target cell from a first TCI state set, and wherein the first TCI state set is one of the TCI state set indicated by the first indication information.

According to still another aspect of the embodiments of this disclosure, there is provided a data transmission method, applicable to a network device, the method including:
transmitting fourth indication information, the fourth indication information indicating at least one TCI state set;
transmitting fifth indication information, the fifth indication information indicating at least one TCI state subset, wherein for a TCI state set, the fifth indication information indicates a TCI state subset in the TCI state set;
transmitting sixth indication information, the sixth indication information indicating that a terminal equipment is switched to at least one target cell, wherein a target cell is one of candidate cells configured for the terminal equipment; and
transmitting seventh indication information, wherein for a target cell, the seventh indication information indicates a TCI state from a second TCI state set that is applied to a third BWP of the target cell, and wherein the TCI state set is one of the TCI state subset indicated by the fifth indication information.

According to yet another aspect of the embodiments of this disclosure, there is provided a data reception apparatus, configured in a terminal equipment, the data reception apparatus including:
a first receiving unit configured to receive first indication information, the first indication information indicating at least one transmission configuration indication (TCI) state set;
a second receiving unit configured to receive second indication information, the second indication information indicating that the terminal equipment is switched to at least one target cell; and
a third receiving unit configured to receive third indication information, wherein for a target cell, the third indication information indicates a TCI state that is applied to a first BWP of the target cell from a first TCI state set, and wherein the first TCI state set is one of the TCI state set indicated by the first indication information.

According to yet still another aspect of the embodiments of this disclosure, there is provided a data reception apparatus, configured in a terminal equipment, the data reception apparatus including:
a fourth receiving unit configured to receive fourth indication information, the fourth indication information indicating at least one TCI state set;
a fifth receiving unit configured to receive fifth indication information, the fifth indication information indicating at least one TCI state subset, wherein for a TCI state set, the fifth indication information indicates a TCI state subset in the TCI state set;
a sixth receiving unit configured to receive sixth indication information, the sixth indication information indicating that the terminal equipment is switched to at least one target cell, wherein a target cell is one of candidate cells configured for the terminal equipment; and
a seventh receiving unit configured to receive seventh indication information, wherein for a target cell, the seventh indication information indicates a TCI state from a second TCI state set that is applied to a third BWP of the target cell, and wherein the second TCI state set is one of the TCI state subset indicated by the fifth indication information.

According to yet further aspect of the embodiments of this disclosure, there is provided a data transmission apparatus, configured in a network device, the data transmission apparatus including:
a first transmitting unit configured to transmit first indication information, the first indication information indicating at least one transmission configuration indication (TCI) state set;
a second transmitting unit configured to transmit second indication information, the second indication information indicating that a terminal equipment is switched to at least one target cell; and
a third transmitting unit configured to transmit third indication information, wherein for a target cell, the third indication information indicates a transmission configuration indication (TCI) state that is applied to a first bandwidth part (BWP) of the target cell from a first transmission configuration indication (TCI) state set, and wherein the first transmission configuration indication (TCI) state set is one of the transmission configuration indication (TCI) state set indicated by the first indication information.

According to yet further another aspect of the embodiments of this disclosure, there is provided a data transmission apparatus, configured in a network device, the data transmission apparatus including:
a fourth transmitting unit configured to transmit fourth indication information, the fourth indication information indicating at least one TCI state set;
a fifth transmitting unit configured to transmit fifth indication information, the fifth indication information indicating at least one TCI state subset, wherein for a TCI state set, the fifth indication information indicates a TCI state subset in the TCI state set;
a sixth transmitting unit configured to transmit sixth indication information, the sixth indication information indicating that a terminal equipment is switched to at least one target cell, wherein a target cell is one of candidate cells configured for the terminal equipment; and
a seventh transmitting unit configured to transmit seventh indication information, wherein for a target cell, the seventh indication information indicates a TCI state from a second TCI state set that is applied to a third BWP of the target cell, and wherein the TCI state set is one of the TCI state subset indicated by the fifth indication information.

An advantage of the embodiments of this disclosure exists in that the terminal equipment receives first indication information, the first indication information indicating at least one transmission configuration indication (TCI) state set; the terminal equipment receives second indication information, the second indication information indicating that the terminal equipment is switched to at least one target cell; and the terminal equipment receives third indication information, wherein for a target cell, the third indication information indicates a TCI state that is applied to a first BWP of the target cell from a first TCI state set, and wherein the first TCI state set is one of the TCI state set indicated by the first indication information. Hence, the terminal equipment is able to quickly use a suitable TCI state after cell switch, thereby reducing handover interruption times.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiments.

FIG. 1 is schematic diagram of a communication system of the embodiments of this disclosure;

FIG. 2 is a schematic diagram of cell switch of LTM of the embodiments of this disclosure;

FIG. 3 is a schematic diagram of beam indication of LTM of the embodiments of this disclosure;

FIG. 4 is a schematic diagram of a data reception method of the embodiments of this disclosure;

FIG. 5 is an exemplary diagram of a process of indicating a TCI state of a target cell of the embodiments of this disclosure;

FIG. 6 is an exemplary diagram of indicating a TCI state of the embodiments of this disclosure;

FIG. 7 is another exemplary diagram of indicating a TCI state of the embodiments of this disclosure;

FIG. 8 is a further exemplary diagram of indicating a TCI state of the embodiments of this disclosure;

FIG. 9 is an exemplary diagram of indicating a target cell of the embodiments of this disclosure;

FIG. 10 is another schematic diagram of the data reception method of the embodiments of this disclosure;

FIG. 11 is a schematic diagram of a data transmission method of the embodiments of this disclosure;

FIG. 12 is another schematic diagram of the data transmission method of the embodiments of this disclosure;

FIG. 13 is a schematic diagram of a data reception apparatus of the embodiments of this disclosure;

FIG. 14 is another schematic diagram of the data reception apparatus of the embodiments of this disclosure;

FIG. 15 is a schematic diagram of a data transmission apparatus of the embodiments of this disclosure;

FIG. 16 is another schematic diagram of the data transmission apparatus of the embodiments of this disclosure;

FIG. 17 is a schematic diagram of a structure of a network device of the embodiments of this disclosure; and

FIG. 18 is a schematic diagram of a terminal equipment of the embodiments of this disclosure.

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, 5G and new radio (NR), etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a node and/or donor in an IAB architecture, a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “terminal equipment (TE) or terminal device” refers to, for example, an equipment accessing to a communication network and receiving network services via a network device. The user equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, it may include but not limited to a machine-type communication (MTC) terminal, a vehicle mounted communication terminal, an industrial wireless device, a surveillance camera, a device to device (D2D) terminal, and a machine to machine (M2M) terminal, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipments described above. “A device” may refer to a network device, and may also refer to a terminal equipment.

Scenarios in the embodiments of this disclosure shall be described below by way of examples; however, this disclosure is not limited thereto.

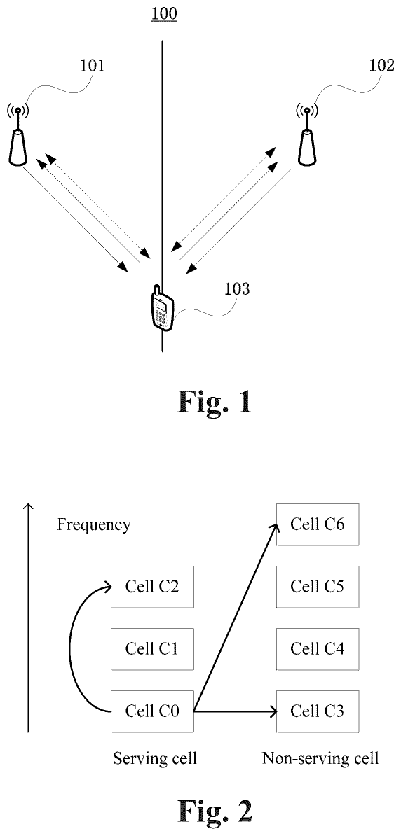

FIG. 1 is a schematic diagram of a communication system of the embodiments of this disclosure, in which a case where a terminal equipment and network devices are taken as examples is schematically shown. As shown in FIG. 1, the communication system 100 may include a first TRP 101, a second TRP 102 and a terminal equipment 103, wherein the first TRP 101 and the second TRP 102 may be network devices. For the sake of simplicity, an example having only two network devices and one terminal equipment is schematically given in FIG. 1. However, the embodiments of this disclosure is not limited thereto.

In the embodiments of this disclosure, existing services or services that may be implemented in the future may be performed between the first TRP 101, the second TRP 102 and the terminal equipment 103. For example, such services may include but not limited to an enhanced mobile broadband (eMBB), massive machine type communication (mMTC), and ultra-reliable and low-latency communication (URLLC), etc.

A unified transmission configuration indication (TCI) has been standardized in Rel-17. Rel-17 ICBM is based on the Rel-17 unified TCI. The Rel-17 unified TCI is for an sTRP scenario, wherein a transmission configuration indication (TCI) field of DCI format 1_1 or DCI format 1_2 indicates one or more TCI states. DCI format 1_1 or DCI format 1_2 may schedule downlink data, referred to as DCI format 1_1/1_2 with DL assignment, or, it may not schedule downlink data, referred to as DCI format 1_1/1_2 without DL assignment. Indication or update of a TCI state actually includes indication or update of beams used by the terminal equipment. TCI states include a joint TCI state, a downlink TCI state, and an uplink TCI state. The joint TCI state acts on a downlink beam (receive beam) and an uplink beam (transmit beam) simultaneously. In other words, the downlink beam and the uplink beam use the same beam, but it is in opposite directions, that is, reciprocity exists between the uplink beam and the downlink beam. The downlink TCI state only acts on a downlink beam. The uplink TCI state only acts on an uplink beam. The uplink beam is also referred to as an uplink transmission spatial filter. For the unified TCI in Rel-17, a TCI field indicates a joint TCI state, or indicates a downlink TCI state, or indicates an uplink TCI state, or indicates a downlink TCI state and an uplink TCI state. Assuming that DCI indicates a TCI state, after a beam application time, the TCI state begins to be applied. The channels or signals applied by the TCI state include dedicated channels or signals for the terminal equipment and a part of common channels or signals. Rel-17 defines a simultaneous TCI update list. In N cells of carrier aggregation, N1 (N1≤M) cells belong to one simultaneous TCI update list, N2 (N2≤M) cells belong to another simultaneous TCI update list, and so on. If update TCI state(s) applied in a cell and the cell belongs to a simultaneous TCI update list, TCI states applied by other cells in the simultaneous TCI update list are also updated accordingly. In other words, TCI states of cells belonging to one simultaneous TCI update list are updated simultaneously.

Rel-18 will study L1/L2 triggered mobility (LTM).

FIG. 2 is a schematic diagram of cell switch of LTM of the embodiments of this disclosure. As shown in FIG. 2, cell C0, cell C1 and cell C2 belong to serving cells. For example, cell C0, cell C1 and cell C2 are a group of cells of carrier aggregation, wherein cell C0 is a primary cell (Pcell), and cell C1 and cell C2 are secondary cells (Scells). For example, the serving cell is at least one of the following: a special cell (SpCell), a Scell, an activated cell, a deactivated cell. Cell C3, cell C4, cell C5 and cell C6 belong to non-serving cells. For example, cell C3, cell C4, cell C5 and cell C6 are a group of cells of carrier aggregation, wherein cell C3 is a Pcell, and cell C4, cell C5 and cell C6 are Scells. Rel-18 LTM supports switching from one cell (e.g. cell C0) to a serving cell, an intra-frequency cell, and an inter-frequency cell. For example, cell C0 may be switched to cell C2 (a serving cell), cell C3 (an intra-frequency cell) and cell C6 (an inter-frequency cell). For example, a cell to which the terminal equipment may possibly be switched is referred as a candidate cell, and a cell to which the terminal equipment is actually switched is referred as a target cell. The terminal equipment is provided with candidate cell configuration, receives a cell switch command and a TCI state indication, is switched to a target cell, and applies an indicated TCI state on the target cell. The terminal equipment may be switched to one or more target cells, such as being switched from a group of serving cells of carrier aggregation (cell C0, cell C1, cell C2) to a group of non-serving cells of carrier aggregation (cell C3, cell C4, cell C5, cell C6).

However, it was found by the inventors that,
Rel-18 will study on L1/L2 triggered mobility (LTM). For Rel-18 LTM, the aim is to reduce a time needed by handover interruption through (layer 1/layer 2 triggered) cell switch based on layer 1/layer 2 signaling, thereby enabling faster switch from a serving cell to a target cell. The target cell is a switched cell, which may be a serving cell or a non-serving cell. Handover interruption refers to a time from the terminal equipment receives a cell switch command to the terminal equipment performs uplink or downlink communication with a target cell for the first time.

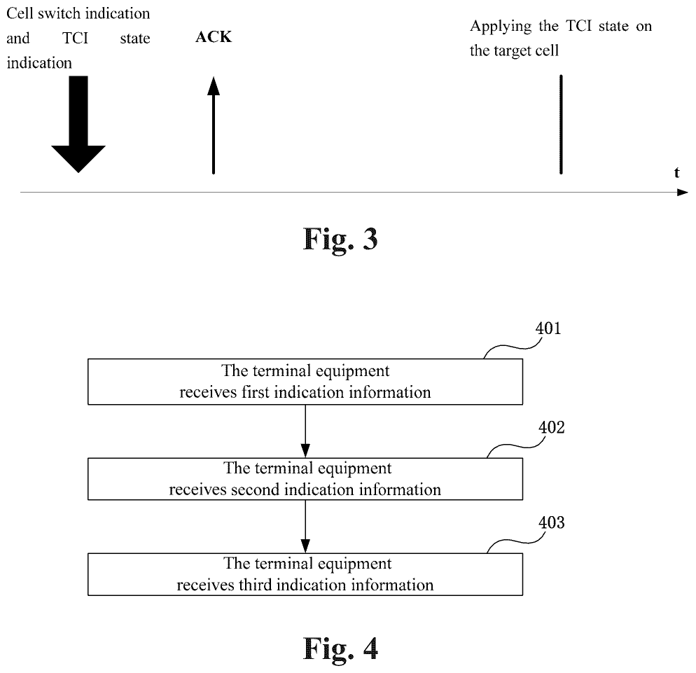

For example, FIG. 3 is a schematic diagram of beam indication of LTM of the embodiments of this disclosure. As shown in FIG. 3, the terminal equipment simultaneously receives a cell switch indication (cell switch command) and a TCI state indication. Optionally, the terminal equipment transmits ACK to the network device, and at a time thereafter, such starting from latter Y symbols after the time when ACK is transmitted, the terminal equipment directly applies the indicated TCI state on the target cell. That is, it is switched directly from the serving cell to the target cell and applies the indicated TCI state.

Compared to legacy cell switch based on layer 3 signaling, cell switch based on layer 1/layer 2 signaling is able to further reduce switch latency. In order to achieve cell switch based on layer 1/layer 2, the terminal equipment needs to measure and report a candidate cell (a cell to which the terminal equipment is possibly switched), and the network device needs to indicate to the terminal equipment a beam (TCI state) to be used on the target cell after switch. Rel-18 LTM may indicate a TCI state based on a Rel-17 unified TCI framework. For ICBM of Rel-17, the terminal equipment does not need to perform cell switch. For Rel-18 LTM, the terminal equipment needs to perform cell switch and switches to the target cell. Due to such a major difference, measurement, reporting and beam indication in Rel-18 LTM need to be designed differently. Therefore, how to indicate a TCI state for a target cell in Rel-18 LTM is still a problem that needs to be solved.

Addressed to at least one of the above problems, embodiments of this disclosure provide a data reception method, a data transmission method and apparatuses thereof.

### Embodiments of a First Aspect

The embodiments of this disclosure provide a data reception method, applicable to a terminal equipment side.

FIG. 4 is a schematic diagram of the data reception method of the embodiments of this disclosure. As shown in FIG. 4, the method includes:

401: the terminal equipment receives first indication information, the first indication information indicating at least one TCI state set;

402: the terminal equipment receives second indication information, the second indication information indicating that the terminal equipment is switched to at least one target cell; and

403: the terminal equipment receives third indication information, wherein for a target cell, the third indication information indicates a TCI state that is applied to a first BWP of the target cell from a first TCI state set, and wherein the first TCI state set is one of the TCI state set indicated by the first indication information.

Hence, the terminal equipment is able to quickly use a suitable TCI state after cell switch based on the first indication information, the second indication information and the third indication information, thereby reducing handover interruption times.

It should be noted that FIG. 4 only schematically illustrates the embodiments of this disclosure; however, this disclosure is not limited thereto. For example, an order of execution of the operations may be appropriately adjusted, and furthermore, some other operations may be added, or some operation therein may be reduced. And appropriate variants may be made by those skilled in the art according to the above contents, without being limited to what is contained in FIG. 4.

In some embodiments of this disclosure, “indication” may be replaced with “configuration”, for example, “RRC signaling indication” may be replaced with “RRC signaling configuration”; and ‘indication’ may also be replaced with ‘activation/deactivation’, for example, ‘MAC CE indication’ may be replaced with ‘MAC CE activation/deactivation’; “TCI state set” may also be referred to as “TCI state pool” or “TCI state list”. For ease of description, this disclosure does not limit these expressions.

In some embodiments, the term ‘DL TCI state’ may be ‘DL only TCI state’ or ‘joint TCI state’, and “UL TCI state” may be “UL only TCI state” or “joint TCI state”; however, the above illustrative only, and the embodiments of this disclosure are not limited thereto.

In some embodiments, the TCI state set is a downlink or joint TCI state set, the TCI state is a downlink or joint TCI state, and the BWP is a downlink BWP; or, the TCI state set is an uplink TCI state set, the TCI state is an uplink TCI state, and the BWP is an uplink BWP.

For example, as described in relevant expressions in this disclosure, “the TCI state set”, “the TCI state” and “the BWP” are applicable to both downlink and uplink. The terminal equipment may apply the data reception method of this disclosure to a certain transmission direction (uplink or downlink), or apply the data reception method of this disclosure to two transmission directions (uplink and downlink) simultaneously.

For example, the TCI state set is a downlink or joint TCI state set, the TCI state is a downlink or joint TCI state, and the BWP is a downlink BWP.

For example, the terminal equipment is configured with one or more downlink or joint TCI state sets, and correspondingly, TCI states in the TCI state set are downlink or joint TCI states, and BWPs that apply the TCI states are downlink BWPs. In other words, the TCI state set described above may be replaced with a downlink or joint TCI state set, the TCI state described above may be replaced with a downlink or joint TCI state, and the BWP described above may be replaced with a downlink BWP. The first TCI state set may also be referred to as a first TCI state set applied to downlink. The first BWP may also be referred to as a first BWP applied to downlink.

For example, the TCI state set is an uplink TCI state set, the TCI state is an uplink TCI state, and the BWP is an uplink BWP.

For example, the terminal equipment is configured with one or more uplink or joint TCI state sets, and correspondingly, TCI states in the TCI state set are uplink or joint TCI states, and BWPs that apply the TCI states are uplink BWPs. In other words, the TCI state set described above may be replaced with an uplink or joint TCI state set, the TCI state described above may be replaced with an uplink or joint TCI state, and the BWP described above may be replaced with an uplink BWP. The first TCI state set may also be referred to as a first TCI state set applied to uplink. The first BWP may also be referred to as a first BWP applied to uplink.

In some embodiments, the TCI state is indicated by a TCI state identifier or a TCI state index.

For example, the above TCI states are indicated by TCI state IDs. For example, the TCI state IDs are numbers for X TCI states; where, X is a maximum number of the TCI states.

For example, the TCI states are indicated by the TCI state IDs, which may be regarded as a global number. Assuming X is a maximum number of TCI states that may be supported in a BWP of a cell (or a cell), the TCI state IDs may be numbered from 0 to X−1, or from 1 to X. For example, a value of X may be 128 or 64, etc., which is not limited in this disclosure.

In some embodiments, the TCI states are indicated by TCI state indices, which are numbers for Y TCI states; where, Y is the number of TCI states in a TCI state set. For example, the TCI states are indicated by the TCI state indices, which may be regarded as a local number. The first indication information indicates a TCI state set for a BWP of a cell. For a TCI state set, assuming that Y is the number of TCI states included in the TCI state set, the TCI state indices may be numbered from 0 to Y−1, or from 1 to Y. For example, a value of Y may be 8, etc., which is not limited in this disclosure.

In some embodiments, the target cell is one of at least one candidate cell configured for the terminal equipment, the at least one candidate cell including a serving cell and/or a non-serving cell.

For example, as shown in FIG. 2, the at least one candidate cell may be configured as including {cell C1, cell C2, cell C3, cell C4, cell C5, cell C6}, and the target cell is one or more of {cell C1, cell C2, cell C3, cell C4, cell C5, cell C6}.

A process of how to indicate the TCI state of the target cell shall be briefly exemplified below.

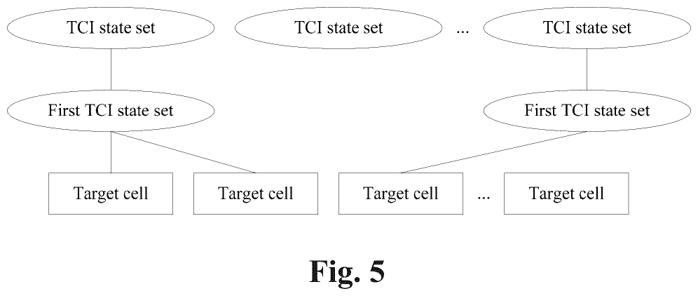

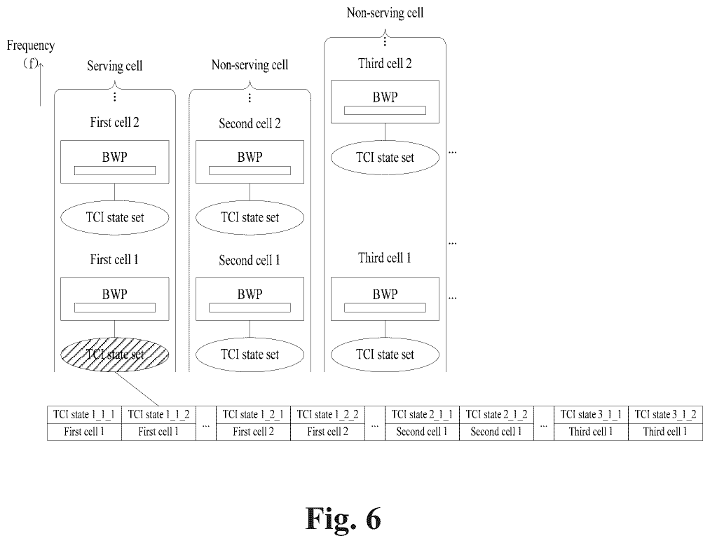

FIG. 5 is an exemplary diagram of a process of indicating a TCI state of a target cell of the embodiments of this disclosure. As shown in FIG. 5, for example, the first indication information indicates at least one TCI state set, the second indication information indicates cell switch and necessary information needed in the cell switch, and the third indication information indicates beam information, such as indicating a TCI state used for a cell after switching from a TCI state set. The above description is applicable to a single transmission direction (downlink or uplink). As shown in FIG. 5, for example, the terminal equipment is indicated (or configured with) one or more TCI state sets by the first indication information. A TCI state set is associated with a bandwidth part (BWP) of a cell, in other words, the TCI state set is configured per cell per BWP; or, a TCI state is associated with a user equipment (UE), in other words, the TCI state set is configured per UE and is UE specific. For example, the terminal equipment is indicated by the second indication information to be switched to one or more target cells. The terminal equipment has been configured with one or more candidate cells, wherein the candidate cell is a cell to which the terminal equipment may possibly be switched, and the target cell is one of the candidate cells configured for the terminal equipment, i.e. a cell to which the terminal equipment is switched. For example, the third indication information indicates a TCI state for each target cell, and for a target cell, the third indication information indicates a TCI state from a TCI state set (a first TCI state set) associated with the target cell; first TCI state sets with which different target cells are associated may be identical or different; for a target cell, the TCI state indicated by the third indication information is applied to a BWP (first BWP) of the target cell, in other words, after being switched to the target cell, the terminal equipment uses the TCI state indicated by the third indication information on the first BWP of the target cell.

How to indicate the TCI state set, the first TCI state set, the target cell and the first BWP shall be explained below separately.

How to indicate a TCI state set shall be explained below.

In some embodiments, that the first indication information indicates at least one TCI state set includes at least one of the following: the first indication information indicates a TCI state set for the terminal equipment; for a serving cell, the first indication information indicates a TCI state set for a BWP of the serving cell; or, for a candidate cell, the first indication information indicates a TCI state set for a BWP of the candidate cell.

In some embodiments, in the case where the first indication information indicates a TCI state set for the terminal equipment, or in the case where the first indication information indicates a TCI state set for a BWP of the serving cell, the TCI state set includes at least one first TCI state and at least one second TCI state, or the TCI state set includes at least one second TCI state, wherein the first TCI state is applied to the BWP of the serving cell, and the second TCI state is applied to the BWP of the candidate cell.

In some embodiments, the TCI state set is indicated in serving cell configuration information.

FIG. 6 is an exemplary diagram of indicating a TCI state of the embodiments of this disclosure. As shown in FIG. 6, for a serving cell, the first indication information indicates a TCI state set for a BWP of the serving cell. The first indication information indicates at least one TCI state set for at least one serving cell. For example, at least one serving cell is represented by at least one first cell, and at least one non-serving cell is represented by at least one second cell, third cell, etc. FIG. 6 only shows a case where each cell has one BWP, which may be easily extended to a case where each cell corresponds to multiple BWPs. For example, the method shown in FIG. 6 is applied to each BWP of each cell, which shall not be enumerated in this disclosure. As shown in FIG. 6, without causing confusion, when a cell is referred, a BWP of the cell is also referred at the same time.

For example, the terminal equipment is switched from a serving cell (such as first cell 1) to a target cell. For a serving cell (first cell 1 is taken as an example, and it may also be another serving cell), its BWP is configured with a TCI state set. The TCI state set may include a second TCI state applied to the BWP of the candidate cell, such as including a TCI state associated with first cell 2, second cell 1, second cell 2 . . . , third cell 1, third cell 2 . . . , such as TCI state 1_2_1, TCI state 1_2_2, TCI state 2_1_1, TCI state 2_1_2, TCI state 3_1_1, TCI state 3_1_2 shown in FIG. 6. It should be noted that TCI state 1_2_1, TCI state 1_2_2, TCI state 2_1_1, TCI state 2_1_2, TCI state 3_1_1, TCI state 3_1_2 shown in FIG. 6 are intended to distinguish TCI states of different cells, wherein specific values of TCI state 1_2_1, TCI state 1_2_2, TCI state 2_1_1, TCI state 2_1_2, TCI state 3_1_1, TCI state 3_1_2 may be identical or different, and reference may be made to the above definitions for TCI state X or TCI state Y for TCI state 1_2_1, TCI state 1_2_2, TCI state 2_1_1, TCI state 2_1_2, TCI state 3_1_1, TCI state 3_1_2, which shall not be repeated herein any further. Optionally, the TCI state set may also include the first TCI state applied to the BWP of the first cell 1, such as including one or more TCI states associated with the first cell 1, such as TCI state 1_1_1 and TCI state 1_1_2 shown in FIG. 6. The candidate cell may include a non-serving cell (such as second cell 1, second cell 2 . . . , third cell 1, third cell 2 . . . ), and may include a serving cell (such as first cell 2 . . . ). A TCI state set may include TCI states associated with multiple candidate cells. In a TCI state set, the number of TCI states associated with a cell may be one or more. Without loss of generality, description is given here by taking that a serving cell (first cell 1) is configured with a TCI state set as an example, and may be easily extended to a case where multiple serving cells are configured with multiple TCI state sets, for example, each serving cell in multiple serving cells is configured with a TCI state set, and these TCI state sets are at least one TCI state set indicated by the first indication information.

For another example, the first indication information indicates a TCI state set for the terminal equipment; in other words, the TCI state set is configured in a UE-specific manner, that is, each terminal equipment is associated with a TCI state set, rather than being configured per cell per BWP, namely, it is not necessary that each cell is associated with a TCI state set. The TCI state set includes the TCI state applied to the BWP of the candidate cell.

In some embodiments, the TCI state set is indicated in the serving cell configuration information (“serving cell configuration”).

For example, the TCI state set is configured in “serving cell configuration”. As shown in FIG. 6, the BWP of the serving cell is configured with a TCI state set, the TCI state set being configured in the configuration information of the serving cell (such as being configured in information element (IE) “ServingCellConfig” providing the serving cell configuration information). For example, the TCI state set is a downlink or joint TCI state set, which is configured in “PDSCH-Config” under “ServingCellConfig”. For example, the TCI state set is an uplink TCI state set, which is configured in “BWP-UplinkDedicated” under “ServingCellConfig”.

For another example, the first indication information indicates a UE-specific TCI state set for the terminal equipment, which is configured in an IE “CellGroupConfig” providing the serving cell configuration information.

For example, reference may be made to the related art for specific contents and/or formats of the above information elements (IEs), such as “ServingCellConfig”, “PPDSCH-Config”, and “BWP-UplinkDedicated”, etc., which are not limited in this disclosure.

In some embodiments, in the case where the first indication information indicates a TCI state set for a BWP of the candidate cell, the TCI state set includes at least one third TCI state, wherein the third TCI state is applied to the BWP of the candidate cell.

In some embodiments, the TCI state set is indicated in candidate cell configuration information.

For example, for a candidate cell, the first indication information indicates a TCI state set for a BWP of the candidate cell, the TCI state set including at least one third TCI state, wherein the third TCI state is applied to the BWP of the candidate cell.

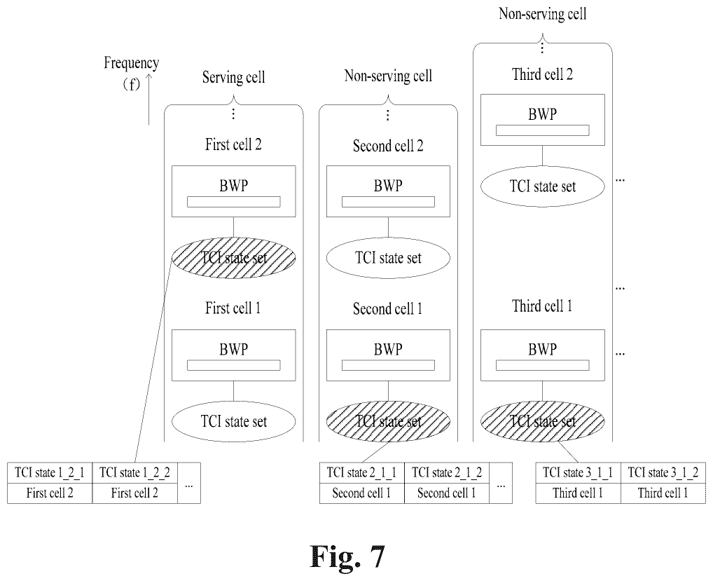

FIG. 7 is another exemplary diagram of indicating a TCI state of the embodiments of this disclosure. For example, as shown in FIG. 7, the first indication information indicates at least one TCI state set for at least one candidate cell. For example, the terminal equipment needs to be switched from a serving cell (such as first cell 1) to one or more of the candidate cells. The candidate cells may include non-serving cells (such as second cell 1, second cell 2 . . . , third cell 1, third cell 2 . . . ), and may include a serving cell (such as first cell 2 . . . ). A BWP of each candidate cell is configured with a TCI state set, the TCI state set including one or more third TCI states applied to the BWP of the candidate cell, such as TCI state 1_2_1, TCI state 1_2_2, TCI state 2_1_1, TCI state 2_1_2, TCI state 3_1_1, TCI state 3_1_2 shown in FIG. 7.

In some embodiments, the TCI state set is indicated in ‘candidate cell configuration’.

For example, the TCI state set is configured in ‘candidate cell configuration’. As shown in FIG. 7, a BWP of each candidate cell is configured with a TCI state set, the TCI state set being configured in the candidate cell configuration information (e.g. such as being configured in an IE “CellGroupConfig” providing the candidate cell configuration information). For example, the TCI state set is a downlink or joint TCI state set, and is configured in “PDSCH-Config” under “ServingCellConfig” in “CellGroupConfig”. For example, the TCI state set is an uplink TCI state set, and is configured in “BWP-UplinkDedicated” under “ServingCellConfig” in “CellGroupConfig”.

For example, reference may be made to the related art for specific contents and/or formats of the above information elements (IEs), such as “CellGroupConfig”, “ServingCellConfig”, “PDSCH-Config”, and “BWP-UplinkDedicated”, etc., which are not limited in this disclosure.

In some embodiments, the first indication information indicates a downlink or joint TCI state set for a downlink BWP of a first serving cell or a first candidate cell, and/or indicates an uplink TCI state set for an uplink BWP of a second serving cell or a second candidate cell. For example, the first serving cell and the second serving cell are identical or different, and the first candidate cell and the second candidate cell are identical or different.

For example, taking that the first serving cell and the second serving cell are identical as an example, as shown in FIG. 6, a BWP of the serving cell is configured with a TCI state set, a downlink BWP of the serving cell is configured with a downlink or joint TCI state set, and/or an uplink BWP of the serving cell is configured with an uplink TCI state set.

For example, taking that the first candidate cell and the second candidate cell are identical as an example, as shown in FIG. 7, a BWP of the candidate cell is configured with a TCI state set, a downlink BWP of the candidate cell is configured with a downlink or joint TCI state set, and/or an uplink BWP of the candidate cell is configured with an uplink TCI state set.

In some embodiments, the first indication information indicates a downlink or joint TCI state set for the terminal equipment, and/or indicates an uplink TCI state set for the terminal equipment

For example, the first indication information configures the TCI state set in a UE-specific manner, and configures a downlink or joint TCI state set for the terminal equipment to indicate a downlink or joint TCI state for the target cell, and/or configures an uplink TCI state set for the terminal equipment to indicate an uplink TCI state for the target cell.

In some embodiments, ‘unifiedTCI-StateType’ configured for the serving cell or candidate cell is ‘joint’ or ‘separate’.

For example, for a cell (a serving cell or a candidate cell), “unifiedTCI-StateType” is a unified TCI state type configured for the cell. As shown in FIG. 7, for a candidate cell, that ‘unifiedTCI-StateType’ is ‘joint’ indicates that the candidate cell is configured with a ‘downlink or joint TCI state set’, and that ‘unifiedTCI-StateType’ is ‘separate’ indicates that the candidate cell is configured with ‘a downlink or joint TCI state set’ and ‘an uplink TCI state set’. As shown in FIG. 6, for a serving cell, regardless of whether “unifiedTCI-StateType” configured for the serving cell is “joint” or “separate”, the serving cell may be configured with “a downlink or joint TCI state set” and “an uplink TCI state set”. This is because that the TCI state set here is used to indicate TCI states of the candidate cell, and whether an uplink TCI state set is needed is dependent on “unifiedTCI-StateType” of the candidate cell, but not on “unifiedTCI-StateType” of the serving cell.

In some embodiments, in the case where the first indication information indicates a TCI state set for a BWP of the serving cell, in a case where a unified TCI state type (unifiedTCI-StateType) configured for at least one candidate cell is separate, the first indication information indicates a downlink or joint TCI state set for a downlink BWP of the first serving cell, and indicates an uplink TCI state set for an uplink BWP of the second serving cell, wherein the first serving cell and the second serving cell are identical or different.

In some embodiments, in the case where the first indication information indicates a TCI state set for the terminal equipment, in a case where a unified TCI state type (unifiedTCI-StateType) configured for at least one candidate cell is separate, the first indication information indicates a downlink or joint TCI state set for the terminal equipment, and indicates an uplink TCI state set for the terminal equipment.

For example, that the first serving cell and the second serving cell are identical is taken as an example. As described above, for a serving cell, regardless of whether “unifiedTCI-StateType” configured for the serving cell is “joint” or “separate”, the serving cell may be configured with “a downlink or joint TCI state set” and “an uplink TCI state set”; furthermore, in a case where ‘unifiedTCI-StateType’ configured for at least one candidate cell is ‘separate’, the serving cell needs to be configured with ‘a downlink or joint TCI state set’ and ‘an uplink TCI state set’. This is because that as long as ‘unifiedTCI-StateType’ configured for a candidate cell is ‘separate’, it is needed to configure an uplink TCI state set that is able to be used to indicate an uplink TCI state to the candidate cell for the serving cell. The ‘downlink or joint TCI state set’ and/or the ‘uplink TCI state set’ here include(s) TCI state(s) applied to a candidate cell. It is assumed above that the first indication information indicates a TCI state set for the BWP of the serving cell, likewise, the above method may also be applied to the case where the first indication information indicates a TCI state set for the terminal equipment, which shall not be repeated herein any further.

In some embodiments, when “unifiedTCI-StateType” configured for all candidate cells is “joint”, the first indication information indicates “a downlink or joint TCI state set” for a downlink BWP of the first serving cell, or, the first indication information indicates ‘a downlink or joint TCI state set’ for the terminal equipment.

For example, in the case where “unifiedTCI-StateType” configured for all candidate cells are “joint”, identical TCI states are used for uplink and downlink, hence, only one “downlink or joint TCI state set” may be configured, wherein “the downlink or joint TCI state set” includes TCI states applied to the candidate cells.

How to determine the first TCI state set shall be described below.

In some embodiments, in the case where the first indication information indicates a TCI state set for the terminal equipment, the first TCI state set is the TCI state set that is indicated.

For example, for a certain transmission direction, if the first indication information configures a unique TCI state set in a UE-specific manner, the first TCI state set is the TCI state set.

In some embodiments, in the case where the first indication information indicates a TCI state set for a BWP of the serving cell, the first indication information indicates a TCI state set for a BWP of a serving cell, the first TCI state set being the TCI state set that is indicated.

For example, the first indication information is limited only to indicating a TCI state set for a BWP of a serving cell, and the first TCI state set is the TCI state set that is indicated.

For example, as shown in FIG. 6, the BWP of the serving cell is configured with a TCI state set; for a transmission direction (downlink or uplink), it is limited only to configuring a TCI state set shown in FIG. 6; in other words, even if there are multiple serving cells (or BWPs), it only configures a TCI state set for a BWP of one serving cell therein. For example, in FIG. 6, a TCI state set is configured only for first cell 1, and TCI state sets are not configured for other first cells. Therefore, the first TCI state set is the configured TCI state set. Without loss of generality, the single transmission direction is described above only, which is easily to be extended to a case of multiple transmission directions. For example, the first indication information may configure “a downlink or joint TCI state set” for a downlink BWP of the first serving cell, and configure “an uplink TCI state set” for an uplink BWP of the second serving cell, wherein the first serving cell and the second serving cell may be identical or different, the first TCI state set applied to downlink is the configured “downlink or joint TCI state set”, and the first TCI state set applied to uplink is the configured “uplink TCI state set”.

For example, the first indication information is limited only to indicating a TCI state set for a BWP of a primary cell (Pcell), the first indication information configures “a downlink or joint TCI state set” for a downlink BWP of the Pcell, and configures “an uplink TCI state set” for an uplink BWP of the primary cell (Pcell). The first TCI state set applied to downlink is the configured “downlink or joint TCI state set”, and the first TCI state set applied to uplink is the configured “uplink TCI state set”.

In some embodiments, in the case where the first indication information indicates a TCI state set for a BWP of the serving cell, the second indication information further indicates a serving cell and a BWP of the serving cell, wherein the first TCI state set is the TCI state set indicated for the BWP of the serving cell by the second indication information.

For example, the second indication information indicates the serving cell and the BWP of the serving cell, and the first TCI state set is the TCI state set configured for the BWP of the serving cell.

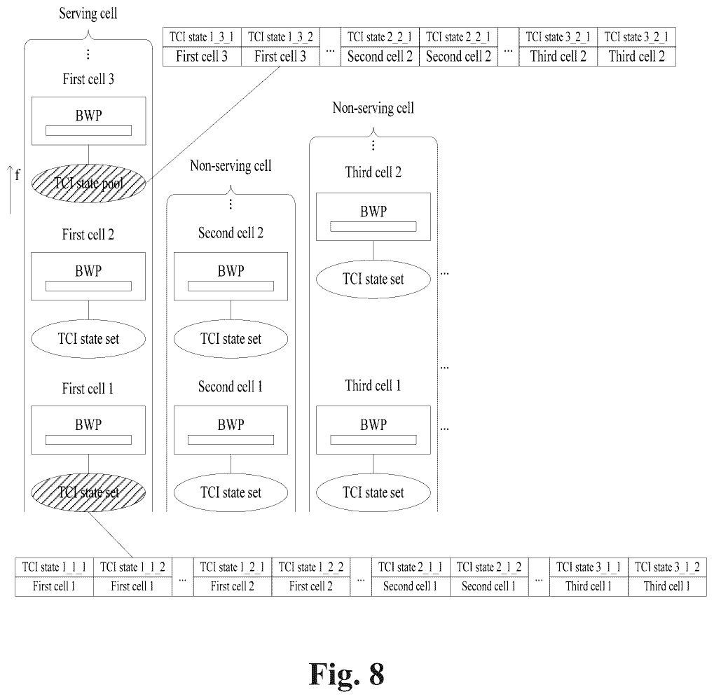

FIG. 8 is a further exemplary diagram of indicating a TCI state of the embodiments of this disclosure. As shown in FIG. 8, the terminal equipment is configured with multiple serving cells, wherein BWPs of more than one serving cells (first cell 1 and first cell 3) are configured with TCI state sets similar to those in FIG. 6, which shall not be repeated herein any further. In the multiple TCI state sets, it is further needed to determine a TCI state set from which the third indication information indicates the TCI states, i.e. determining the first TCI state set. For example, the second indication information is information carried by the cell switch command, the second indication information indicates (i.e. the cell switch command indicates) a serving cell ID and a BWP ID. As the TCI state sets are configured per cell per BWP, a serving cell and a BWP of the serving cell may uniquely determine a TCI state set. Therefore, the first TCI state set is the determined TCI state set. Without loss of generality, the single transmission direction is described above only, which is easily to be extended to a case of multiple transmission directions. For example, the second indication information indicates a first serving cell and a downlink BWP of the first serving cell, and indicates a second serving cell and an uplink BWP of the second serving cell, wherein the first serving cell and the second serving cell may be identical or different. The first TCI state set applied to downlink is the TCI state set configured for the downlink BWP of the first serving cell, and the first TCI state set applied to uplink is the TCI state set configured for the uplink BWP of the second serving cell. For example, reference may be made to relevant explanations in FIG. 6 for the specifically indicated TCI state in the first TCI state set, which shall not be repeated herein any further.

In some embodiments, the terminal equipment receives the second indication information on the downlink BWP of the serving cell, and the first TCI state set applied to downlink is the TCI state set configured for the downlink BWP of the serving cell, and/or, the first TCI state set applied to uplink is the TCI state set configured for an uplink BWP of the serving cell, the uplink BWP being predefined or being indicated by the second indication information.

For example, the second indication information is information carried by the cell switch command, and if the terminal equipment receives the cell switch command on a downlink BWP of a serving cell, the first TCI state set applied to downlink is the “downlink or joint TCI state set” configured for the downlink BWP of the serving cell, and the first TCI state set applied to uplink is an uplink TCI state set configured for an uplink BWP of the serving cell. The uplink BWP may be predefined BWP, such as a currently activated uplink BWP or an initial uplink BWP, and the uplink BWP may also be the uplink BWP indicated by the second indication information.

In some embodiments, in the case where the first indication information indicates a TCI state set for a BWP of the candidate cell, for a target cell, the first TCI state set is the TCI state set indicated for the first BWP of the target cell.

For example, as shown in FIG. 7, a BWP of each candidate cell is configured with a TCI state set, wherein in the multiple TCI state sets, it is further needed to determine a TCI state set from which the third indication information indicates the TCI state, i.e. determining the first TCI state set. The terminal equipment is switched to one or more target cells. For a target cell, the first TCI state set is a TCI state set configured for a first BWP of the target cell, in other words, each target cell is associated with a first TCI state set.

How to determine the target cell shall be described below.

In some embodiments, the target cell is indicated by the second indication information, or is determined according to a reference signal in the TCI state indicated by the third indication information.

For example, the target cell is determined by the reference signal in the TCI state indicated by the third indication information.

For example, if the reference signal in the TCI state indicated by the third indication information is from the first candidate cell, the target cell is the first candidate cell. As shown in FIG. 6, the third indication information indicates a TCI state from the first TCI state set. For an indicated TCI state, as shown in Table 1, it expresses an “TCI state” IE, when a “candideCell” IE exists, it indicates that the reference signal in the TCI state is from a candidate cell, wherein “CandidateCellIndex” indicates a cell ID or PCI ID of the candidate cell, and when the “candideCell” IE does not exist, it indicates that the reference signal in the TCI state is from the serving cell (which is not a candidate cell); and if the third indication information indicates the TCI state that a reference signal is from the candidate cell, the target cell applying the TCI state is the candidate cell.

TABLE 1
“TCI State” IE

| TCI-State ::= | SEQUENCE { |
|---|---|
| ... | |
| candidateCell | CandidateCellIndex |

OPTIONAL, -- Need R
...
}

In some embodiments, the target cell is indicated by the second indication information.

In some embodiments, one or more target cells are explicitly indicated by the second indication information. For example, the second indication information indicates the target cell by indicating “candidate configuration index” and “cell ID”.

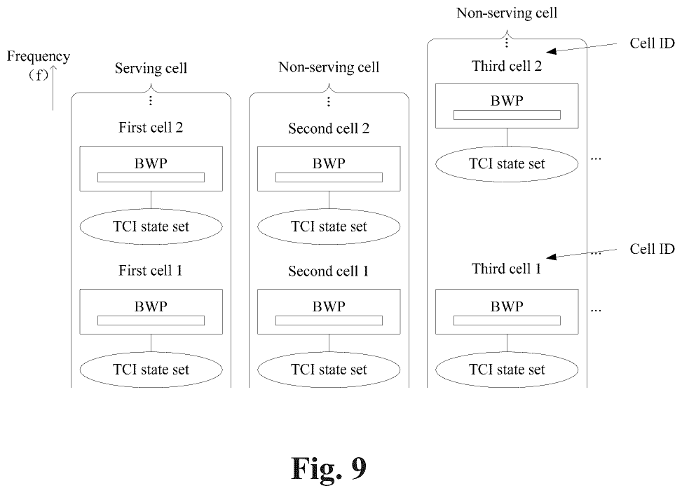

FIG. 9 is an exemplary diagram of indicating a target cell of the embodiments of this disclosure. As shown in FIG. 9, “candidate cell configuration” configures one or more groups of candidate cells. For example, a group of candidate cells is a group of non-serving cells in the figure, and the group of candidate cells may be a group of cells of carrier aggregation, such as {third cell 1, third cell 2 . . . }; ‘candidate configuration index’ is taken as a group index and is used to determine a group of candidate cells. In a group of candidate cells, the cell ID further determines that a candidate cell in the group is taken as the target cell, such as third cell 1 in {third cell 1, third cell 2 . . . }.

In some embodiments, in the candidate cell with which ‘candidate configuration index’ is associated, if the second indication information only indicates that a part of candidate cells are taken as target cells, candidate cells that are not indicated are deemed deactivated cells.

For another example, the second indication information indicates in a group of non-serving cells in FIG. 9 that a part of candidate cells are taken as target cells. The terminal equipment is switched to these target cells and deems that these target cells are cells of carrier aggregation, and cells that are not indicated are deemed as deactivated cells in carrier aggregation. For example, for a group of non-serving cells {third cell 1, third cell 2 . . . }, it may only be indicated that third cell 1 is a target cell, and for third cell 2 that is not indicated, it is a deactivated cell.

How to determine the first BWP shall be described below.

In some embodiments, the first BWP of the target cell is indicated by the second indication information, or is determined according to candidate cell configuration information.

In some embodiments, the first BWP of the target cell is indicated by the second indication information.

For example, a target cell may be configured with multiple BWPs, and the second indication information indicates that one of the BWPs is taken as the first BWP. A first BWP of a target cell is associated with the TCI state indicated by the third indication information, and the terminal equipment applies the TCI state indicated by the third indication information on the first BWP of the target cell.

In some embodiments, the first BWP is determined by the indication information in the candidate cell configuration.

For example, the IE “CellGroupConfig” provides the candidate cell configuration information. In “CellGroupConfig”, a first BWP applied to downlink (a downlink BWP) is determined by “firstActiveDownlinkBWP-Id” under “ServingCellConfig”, and a first BWP applied to uplink (an uplink BWP) is determined by “firstActiveUplinkBWP-Id” under “UplinkConfig” in “ServingCellConfig”. Here, both “firstActiveDownlinkBWP-Id” and “firstActive UplinkBWP-Id” are indication information in “candidate cell configuration”.

Applying a TCI state on a target cell shall be described below.

In some embodiments, the terminal equipment applies the TCI state indicated by the third indication information on a second BWP of a second target cell, wherein the second target cell is in the same TCI state update list as the target cell, and BWP IDs of the second BWP and the first BWP are identical.

In some embodiments, the third indication information indicates a fourth TCI state applied to a fourth BWP of the first target cell, and the terminal equipment applies the fourth TCI state on a fifth BWP of the second target cell, wherein the second target cell and the first target cell are in the same TCI state update list, and BWP IDs of the fourth BWP and the fifth BWP are identical.

For example, the terminal equipment determines TCI states of the target cells according to the third indication information and the TCI state update list, and the terminal equipment is switched to multiple target cells of carrier aggregation, hence, a TCI state needs to be applied on each target cell; ‘candidate cell configuration’ includes configuration of the TCI state update list, for example, ‘CellGroupConfig’ providing the “candidate cell”' configuration information includes one or more TCI state update lists ('simultaneousU-TCI-UpdateList'), in which case the third indication information does not need to indicate a TCI state for each target cell. The terminal equipment may determine the TCI state of each target cell according to the third indication information and the TCI state update list, and if the first target cell and the second target cell belong to the same TCI state update list and the third indication information indicates a TCI state applied to a certain BWP (a fourth BWP) of the first target cell, the terminal equipment also applies the TCI state on a BWP (a fifth BWP) with an identical BWP ID in the second target cell.

In some embodiments, in a case where the unified TCI state type (unifiedTCI-State Type) configured for the target cell is joint, the terminal equipment applies the TCI state indicated by the third indication information on a downlink BWP and an uplink BWP of the target cell.

For example, if the third indication information indicates a TCI state applied to the target cell and ‘unifiedTCI-StateType’ configured for the target cell is ‘joint’, the terminal equipment applies the TCI state on the downlink BWP and uplink BWP of the target cell.

For example, for a target cell, the terminal equipment determines TCI states of a downlink BWP and an uplink BWP according to the third indication information and “unifiedTCI-StateType”; ‘candidate cell configuration’ includes configurations of ‘unifiedTCI-StateType’ of the candidate cells. When ‘unifiedTCI-StateType’ of the target cells is ‘joint’, the third indication information may only indicate one TCI state, and the terminal equipment applies the TCI state to both the first BWP applied to downlink and the first BWP applied to uplink.

In some embodiments, the third indication information indicates more than one TCI states for the first BWP of the target cell, wherein the more than one TCI states are TCI states activated for the first BWP of the target cell, and a first TCI state in the multiple TCI states is the TCI state applied to the first BWP of the target cell.

For example, for a BWP of a target cell, the third indication information indicates more than one TCI states for the BWP, wherein a first TCI state is a TCI state applied to the BWP, and the more than one TCI states are TCI state activated for the BWP.

For example, for a target cell, the third indication information not only indicates a TCI state applied on the target cell, but also indicates a TCI state activated for the target cell. With this method, after switching to the target cell, when it needs to update TCI states, DCI may be directly used to indicate a TCI state from the activated TCI states and take it as the TCI state applied on the target cell, thereby enabling faster beam update. For a BWP of a target cell, the third indication information indicates multiple TCI states, and these TCI states are taken as TCI states activated for the BWP, wherein a first TCI state is the TCI state applied on the BWP by default, that is, the terminal equipment may apply the first TCI state on the BWP after being switched to the target cell. Without loss of generality, ‘a first TCI state’ may be replaced with ‘a last TCI state’, or any designated TCI state.

In this disclosure, the “first indication information” may include one or more information, collectively referred to as first indication information for simplicity. The above explanations are also applicable to the second indication information and the third indication information.

In some embodiments, the first indication information is carried by RRC signaling, and/or, the second indication information is carried by an MAC CE, and/or, the third indication information is carried by an MAC CE or DCI.

In some embodiments, the second indication information and the third indication information are carried by one MAC CE; or, the second indication information is carried by an MAC CE, the third indication information is carried by another MAC CE, and the MAC CE carrying the second indication information and the MAC CE carrying the third indication information are carried by a PDSCH; or, the second indication information is carried by an MAC CE, the third indication information is carried by DCI and at least one MAC CE, and the MAC CE carrying the second indication information and the MAC CE carrying the third indication information are carried by a PDSCH scheduled by the DCI.

In some embodiments, the first indication information is carried by RRC signaling.

For example, the first indication information is carried by one or more RRC signaling (or RRC IE(s)). ‘The first indication information is carried by RRC signaling’ may be replaced with ‘the TCI state set is configured by RRC signaling’, such as being configured per cell per BWP. ‘The first indication information indicates’ may be replaced with ‘the first indication information configures’.

In some embodiments, the second indication information is carried by an MAC CE.

For example, the second indication information is carried by a cell switch command, which is a type of MAC CE, and the second indication information is carried by one or more fields of an MAC CE. ‘The second indication information is carried by an MAC CE’ may be replaced with ‘a content indicated by the second indication information is indicated by an MAC CE’.

In some embodiments, the second indication information and the third indication information are carried by an MAC CE.

For example, the cell switch command is a type of MAC CE, the MAC CE indicating cell switch (carrying the second indication information) and indicating a TCI state (carrying the third indication information) for a BWP of each target cell. ‘The second indication information and the third indication information are carried by an MAC CE’ may be replaced with ‘contents indicated by the second indication information and the third indication information are indicated by an MAC CE’.

In some embodiments, the second indication information is carried by an MAC CE, the third indication information is carried by at least one MAC CE, and the MAC CE carrying the second indication information and the MAC CE carrying the third indication information are carried by a PDSCH.

For example, the second indication information is carried by an MAC CE (such as a cell switch command), the third indication information is carried by at least one MAC CE, and all of these MAC CEs are carried by a PDSCH. ‘The third indication information is carried by at least one MAC CE’ may be replaced with ‘a TCI state is indicated by at least one MAC CE’, for example, for at least one target cell, the TCI state applied to a BWP of each target cell is indicated by an MAC CE.

In some embodiments, the second indication information is carried by an MAC CE, the third indication information is carried by DCI and at least one MAC CE, and the MAC CE carrying the second indication information and the MAC CE carrying the third indication information are carried by a PDSCH scheduled by the DCI.

For example, the second indication information is carried by an MAC CE, the third indication information is carried by DCI and at least one MAC CE, and all of the MAC CEs are carried by the PDSCH scheduled by the DCI. ‘The third indication information is carried by DCI and at least one MAC CE’ may be replaced with ‘the TCI state is indicated by DCI and at least one MAC CE’, for example, for at least one target cell, the TCI state applied to the BWP of the Pcell is indicated by the DCI, and the TCI state applied to the BWP of at least one Scell is indicated by at least one MAC CE.

The process of determining a TCI state by the terminal equipment after the TCI state set, the first TCI state set, the target cell, the first BWP, the TCI state, the first indication information, the second indication information and the third indication information are determined shall be further exemplified.

This disclosure may be any combination of the above embodiments, and some of these combinations shall be exemplified below. For simplicity, only key parts therein shall be explained, and those parts not mentioned may be determined in any one of the methods described above.

For example, the terminal equipment is configured with a UE-specific TCI state set applied to downlink (a first TCI state set applied to downlink) and a UE-specific TCI state set applied to uplink (a first TCI state set applied to uplink), that is, the TCI state sets are not configured per cell per BWP; the terminal equipment receives a cell switch command; for a target cell, the cell switch command indicates a TCI state from the first TCI state set applied to downlink for the first BWP applied to downlink of the target cell, and indicates a TCI state from the first TCI state set applied to uplink for the first BWP applied to uplink of the target cell.

For example, the terminal equipment is configured with one or more serving cells, each of which being configured with one or more downlink BWPs and one or more uplink BWPs, and each BWP of each serving cell being configured with a TCI state set; the terminal equipment receives a cell switch command; the cell switch command indicates a serving cell and a downlink BWP and an uplink BWP of the serving cell; the first TCI state set applied to downlink is a TCI state set configured for the downlink BWP of the serving cell, and the first TCI state set applied to uplink is a TCI state set configured for an uplink BWP of the serving cell; for a target cell, the cell switch command indicates a TCI state from the first TCI state set applied to downlink for the first BWP applied to downlink of the target cell, and indicates a TCI state from the first TCI state set applied to uplink for the first BWP applied to uplink of the target cell.

For example, the terminal equipment is configured with one or more serving cells, each of which being configured with one or more downlink BWPs and one or more uplink BWPs; a downlink BWP of the PCell (or SpCell) is configured with a TCI state set applied to downlink (i.e. the first TCI state set applied to downlink), and an uplink BWP of the PCell (or SpCell) is configured with a TCI state set applied to uplink (i.e. the first TCI state set applied to uplink); the terminal equipment receives a cell switch command; for a target cell, the cell switch command indicates a TCI state from the first TCI state set applied to downlink for the first BWP applied to downlink of the target cell, and indicates a TCI state from the first TCI state set applied to uplink for the first BWP applied to uplink of the target cell.

For example, the terminal equipment is configured with one or more candidate cells, each of which being configured with one or more downlink BWPs and one or more uplink BWPs, and each BWP of each candidate cell being configured with a TCI state set; the terminal equipment receives a cell switch command; the cell switch command indicates one or more candidate cells; for a target cell, the first TCI state set applied to downlink is a TCI state set configured for a first BWP applied to downlink of the target cell, and the first TCI state set applied to uplink is a TCI state set configured for a first BWP applied to uplink of the target cell; and for a target cell, the cell switch command indicates a TCI state from the first TCI state set applied to downlink for the first BWP applied to downlink of the target cell, and indicates a TCI state from the first TCI state set applied to uplink for the first BWP applied to uplink of the target cell.

Hence, the terminal equipment is able to quickly use a suitable TCI state after cell switch, thereby reducing handover interruption times.

It should be noted that FIGS. 5-9 only schematically illustrates the embodiments of this disclosure; however, this disclosure is not limited thereto. For example, an order of execution of the operations may be appropriately adjusted, and furthermore, some other operations may be added, or some operation therein may be reduced. And appropriate variants may be made by those skilled in the art according to the above contents, without being limited to what is contained in FIGS. 5-9.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It can be seen from the above embodiment that the terminal equipment is able to quickly use a suitable TCI state after cell switch based on the first indication information, the second indication information and the third indication information, thereby reducing handover interruption times.

### Embodiments of a Second Aspect

The embodiments of this disclosure provide a data reception method, applicable to a terminal equipment side, with contents identical to those in the embodiments of the first aspect being not going to be repeated herein any further.

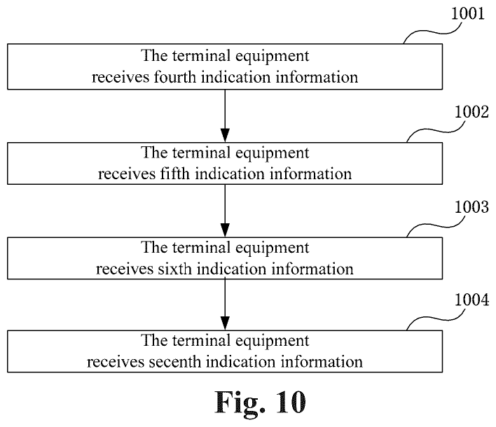

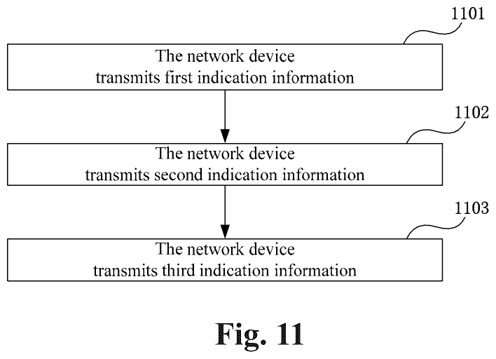

FIG. 10 is another schematic diagram of the data reception method of the embodiments of this disclosure. As shown in FIG. 10, the method includes:

1001: the terminal equipment receives fourth indication information, the fourth indication information indicating at least one TCI state set;

1002: the terminal equipment receives fifth indication information, the fifth indication information indicating at least one TCI state subset, wherein for a TCI state set, the fifth indication information indicates a TCI state subset in the TCI state set;

1003: the terminal equipment receives sixth indication information, the sixth indication information indicating that the terminal equipment is switched to at least one target cell, wherein a target cell is one of candidate cells configured for the terminal equipment; and

1004: the terminal equipment receives seventh indication information, wherein for a target cell, the seventh indication information indicates a TCI state from a second TCI state set that is applied to a third BWP of the target cell, and wherein the second TCI state set is one of the TCI state subset indicated by the fifth indication information.

Hence, the terminal equipment is able to quickly use a suitable TCI state after cell switch, thereby reducing handover interruption times.

It should be noted that FIG. 10 only schematically illustrates the embodiments of this disclosure; however, this disclosure is not limited thereto. For example, an order of execution of the operations may be appropriately adjusted, and furthermore, some other operations may be added, or some operation therein may be reduced. And appropriate variants may be made by those skilled in the art according to the above contents, without being limited to what is contained in FIG. 10.

In some embodiments, in a case where the TCI state subset indicated by the fifth indication information for a BWP of the target cell includes a TCI state, the TCI state is the TCI state applied to the BWP of the target cell.

For example, differences from the embodiments of the first aspect include: after being indicated (configured with) one or more TCI state sets, the terminal equipment is further indicated (activated or configured with) one or more TCI state subsets; for a TCI state set, the fifth indication information indicates a TCI state subset for it, the TCI state subset including one or more TCI states in the above TCI state set; for a target cell, the TCI state applied to the BWP of the target cell is from a TCI state subset; for example, “the TCI state subset” in the embodiments of the second aspect of this disclosure may be correspondingly applied to relevant processes in “the TCI state set” in the embodiments of the first aspect, for example, the method in the embodiments of the first aspect may be reused, and parts similar to those in the embodiments of the first aspect include but not limited to: the method for determining “the second TCI state set” may refer to the above method for determining “the first TCI state set”, the method for determining “the third BWP” may refer to the above method for determining “the first BWP”, specific contents of “the fourth indication information” may refer to “the first indication information” above, specific contents of “the sixth indication information” may refer to “the second indication information” above, and specific contents of “the seventh indication information” may refer to “the third indication information” above, which shall not be repeated herein any further.

In some embodiments, for a target cell, in a case where the TCI state subset indicated by the fifth indication information for a BWP of the target cell includes only one TCI state, the TCI state is the TCI state applied to the BWP of the target cell.

For example, a BWP of a target cell is configured with a TCI state set, and is then activated by the fifth indication information with a unique TCI state in the TCI state set, in which case the TCI state is the TCI state applied to the BWP of the target cell; in other words, the seventh indication information (such as being carried by the cell switch command) may not indicate the TCI state applied to the BWP of the target cell, and the TCI state indicated by the fifth indication information is the TCI state applied to the BWP of the target cell.

In some embodiments, the fifth indication information is carried by an MAC CE.

For example, for a TCI state set configured by the fourth indication information (such as RRC signaling), the fifth indication information (such as an MAC CE) activates one or more TCI states in the TCI state set, i.e. indicating a TCI state subset.

In some embodiments, the fifth indication information indicates a TCI state subset for the serving cell.

For example, the fourth indication information (such as RRC signaling) configures a TCI state set for a BWP of a serving cell, and the fifth indication information (such as an MAC CE) activates one or more TCI states in the TCI state set.

In some embodiments, the fifth indication information indicates a TCI state subset for candidate cell.

For example, the fourth indication information (such as RRC signaling) configures a TCI state set for a BWP of a candidate cell, and the fifth indication information (such as an MAC CE) activates one or more TCI states in the TCI state set.

In some embodiments, the fifth indication information indicates “a candidate configuration index” and “a cell ID”.

For example, in order to determine a candidate cell for which the fifth indication information indicates as a TCI state subset, the fifth indication information indicates a candidate cell by indicating the “candidate configuration index” and the “cell ID”. For example, reference may be to the indication method in the embodiments of the first aspect, which shall not be repeated herein any further.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It can be seen from the above embodiment that the terminal equipment is able to quickly use a suitable TCI state after cell switch based on the fourth indication information, the fifth indication information, the sixth indication information and the seventh indication information, thereby reducing handover interruption times.

### Embodiments of a Third Aspect

The embodiments of this disclosure provide a data transmission method, applicable to a network device side. The embodiments of this disclosure may be implemented in combination with the embodiments of the first aspect, or may be implemented separately, with contents identical to those in the embodiments of the first aspect being not going to be described herein any further.

FIG. 11 is a schematic diagram of the data transmission method of the embodiments of this disclosure. As shown in FIG. 11, the method includes:

1101: the network device transmits first indication information, the first indication information indicating at least one TCI state set;

1102: the network device transmits second indication information, the second indication information indicating that a terminal equipment is switched to at least one target cell; and

1103: the network device transmits third indication information, wherein for a target cell, the third indication information indicates a TCI state that is applied to a first BWP of the target cell from a first TCI state set, and wherein the first TCI state set is one of the TCI state set indicated by the first indication information.

It should be noted that FIG. 11 only schematically illustrates the embodiments of this disclosure; however, this disclosure is not limited thereto. For example, an order of execution of the operations may be appropriately adjusted, and furthermore, some other operations may be added, or some operation therein may be reduced. And appropriate variants may be made by those skilled in the art according to the above contents, without being limited to what is contained in FIG. 11.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It can be seen from the above embodiment that the terminal equipment is able to quickly use a suitable TCI state after cell switch based on the first indication information, the second indication information and the third indication information, thereby reducing handover interruption times.

### Embodiments of a Fourth Aspect

The embodiments of this disclosure provide a data transmission method, applicable to a network device side. The embodiments of this disclosure may be implemented in combination with the embodiments of the first and second aspects, or may be implemented separately, with contents identical to those in the embodiments of the first and second aspects being not going to be described herein any further.

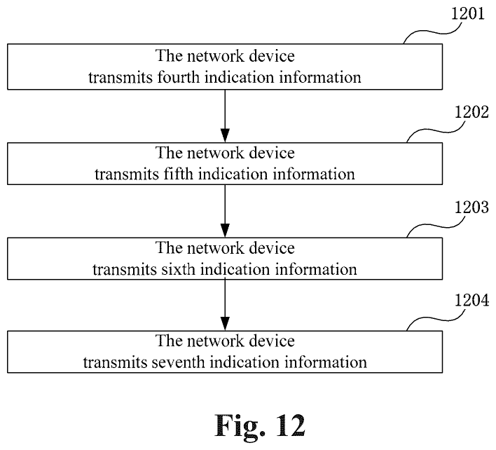

FIG. 12 is a schematic diagram of the data transmission method of the embodiments of this disclosure. As shown in FIG. 12, the method includes:

1201: the network device transmits fourth indication information, the fourth indication information indicating at least one TCI state set;

1202: the network device transmits fifth indication information, the fifth indication information indicating at least one TCI state subset, wherein for a TCI state set, the fifth indication information indicates a TCI state subset in the TCI state set;

1203: the network device transmits sixth indication information, the sixth indication information indicating that a terminal equipment is switched to at least one target cell, wherein a target cell is one of candidate cells configured for the terminal equipment; and

1204: the network device transmits seventh indication information, wherein for a target cell, the seventh indication information indicates a TCI state from a second TCI state set that is applied to a third BWP of the target cell, and wherein the TCI state set is one of the TCI state subset indicated by the fifth indication information.

It should be noted that FIG. 12 only schematically illustrates the embodiments of this disclosure; however, this disclosure is not limited thereto. For example, an order of execution of the operations may be appropriately adjusted, and furthermore, some other operations may be added, or some operation therein may be reduced. And appropriate variants may be made by those skilled in the art according to the above contents, without being limited to what is contained in FIG. 12.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It can be seen from the above embodiment that the terminal equipment is able to quickly use a suitable TCI state after cell switch based on the fourth indication information, the fifth indication information, the sixth indication information and the seventh indication information, thereby reducing handover interruption times.

### Embodiments of a Fifth Aspect

The embodiments of this disclosure provide a data reception apparatus. The apparatus may be, for example, a terminal equipment, or one or some components or assemblies configured in the terminal equipment. Contents in the embodiments identical to those in the embodiments of the first aspect shall not be described herein any further.

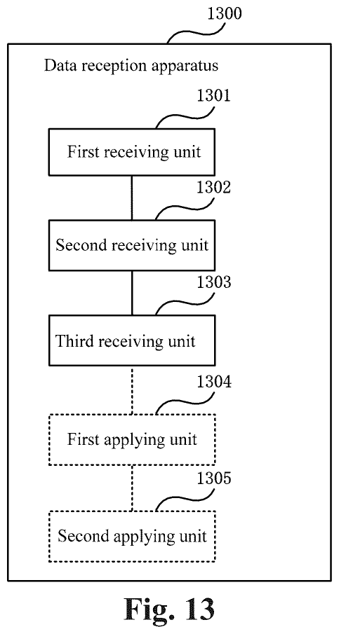

FIG. 13 is a schematic diagram of the data reception apparatus of the embodiments of this disclosure. As shown in FIG. 13, a data reception apparatus 1300 includes:
a first receiving unit 1301 configured to receive first indication information, the first indication information indicating at least one transmission configuration indication (TCI) state set;
a second receiving unit 1302 configured to receive second indication information, the second indication information indicating that the terminal equipment is switched to at least one target cell; and
a third receiving unit 1303 configured to receive third indication information, wherein for a target cell, the third indication information indicates a transmission configuration indication (TCI) state that is applied to a first bandwidth part (BWP) of the target cell from a first transmission configuration indication (TCI) state set, and wherein the first transmission configuration indication (TCI) state set is one of the transmission configuration indication (TCI) state set indicated by the first indication information.

In some embodiments, the target cell is one of at least one candidate cell configured for the terminal equipment, the at least one candidate cell including a serving cell and/or a non-serving cell.

In some embodiments, the first indication information indicating at least one transmission configuration indication (TCI) state set includes at least one of the following:
the first indication information indicating a transmission configuration indication (TCI) state set for the terminal equipment;
for a serving cell, the first indication information indicating a transmission configuration indication (TCI) state set for a bandwidth part (BWP) of the serving cell; or
for a candidate cell, the first indication information indicating a transmission configuration indication (TCI) state set for a bandwidth part (BWP) of the candidate cell.

In some embodiments, in a case where the first indication information indicates a transmission configuration indication (TCI) state set for a bandwidth part (BWP) of the serving cell, in a case where a unified TCI state type (unifiedTCI-StateType) configured for at least one candidate cell is separate, the first indication information indicates a downlink transmission configuration indication (TCI) state set or a joint transmission configuration indication (TCI) state set for a downlink bandwidth part (BWP) of a first serving cell, and indicates an uplink transmission configuration indication (TCI) state set for an uplink bandwidth part (BWP) of a second serving cell, wherein the first serving cell is identical to or different from the second serving cell.

In some embodiments, in the case where the first indication information indicates a TCI state set for the terminal equipment, in a case where a unified TCI state type (unifiedTCI-StateType) configured for at least one candidate cell is separate, the first indication information indicates a downlink or joint TCI state set for the terminal equipment, and indicates an uplink TCI state set for the terminal equipment.

In some embodiments, in a case where the first indication information indicates a transmission configuration indication (TCI) state set for the terminal equipment, or in a case where the first indication information indicates a transmission configuration indication (TCI) state set for a bandwidth part (BWP) of the serving cell, the transmission configuration indication (TCI) state set includes at least one first transmission configuration indication (TCI) state and at least one second transmission configuration indication (TCI) state, or the transmission configuration indication (TCI) state set includes at least one second transmission configuration indication (TCI) state, wherein the first transmission configuration indication (TCI) state is applied to the bandwidth part (BWP) of the serving cell, and the second transmission configuration indication (TCI) state is applied to the bandwidth part (BWP) of the candidate cell.

In some embodiments, the transmission configuration indication (TCI) state set is indicated in serving cell configuration information.

In some embodiments, in a case where the first indication information indicates a transmission configuration indication (TCI) state set for the bandwidth part (BWP) of the candidate cell, the transmission configuration indication (TCI) state set includes at least one third transmission configuration indication (TCI) state, wherein the third transmission configuration indication (TCI) state is applied to the bandwidth part (BWP) of the candidate cell.

In some embodiments, the transmission configuration indication (TCI) state set is indicated in candidate cell configuration information.

In some embodiments, in a case where the first indication information indicates a transmission configuration indication (TCI) state set for the terminal equipment, the first transmission configuration indication (TCI) state set is the indicated transmission configuration indication (TCI) state set.

In some embodiments, in a case where the first indication information indicates a transmission configuration indication (TCI) state set for a bandwidth part (BWP) of the serving cell, the first indication information indicates a transmission configuration indication (TCI) state set for a bandwidth part (BWP) of a serving cell, and the first transmission configuration indication (TCI) state set is the indicated transmission configuration indication (TCI) state set.

In some embodiments, in a case where the first indication information indicates a transmission configuration indication (TCI) state set for a bandwidth part (BWP) of the serving cell, the second indication information further indicates bandwidth parts (BWPs) of a serving cell and the serving cell, wherein the first transmission configuration indication (TCI) state set is the transmission configuration indication (TCI) state set indicated for the bandwidth part (BWP) of the serving cell indicated by the second indication information.

In some embodiments, in a case where the first indication information indicates a transmission configuration indication (TCI) state set for a bandwidth part (BWP) of the candidate cell, for a target cell, the first transmission configuration indication (TCI) state set is the transmission configuration indication (TCI) state set indicated for the first bandwidth part (BWP) of the target cell.

In some embodiments, the target cell is indicated by the second indication information, or is determined according to a reference signal in the transmission configuration indication (TCI) state indicated by the third indication information.

In some embodiments, the first bandwidth part (BWP) of the target cell is indicated by the second indication information, or is determined according to candidate cell configuration information.

In some embodiments, the data reception apparatus 1300 further includes: a first applying unit 1304 configured to apply the transmission configuration indication (TCI) state indicated by the third indication information to a second bandwidth part (BWP) of a second target cell, wherein the second target cell and the target cell are in a transmission configuration indication (TCI) state update list, wherein bandwidth part indices (BWP IDs) of the second bandwidth part (BWP) and the first bandwidth part (BWP) are identical.

In some embodiments, the data reception apparatus 1300 further includes: a second applying unit 1305 configured to apply the transmission configuration indication (TCI) state indicated by the third indication information to a downlink bandwidth part (BWP) and uplink bandwidth part (BWP) of the target cell when a unified TCI state type (unifiedTCI-StateType) configured for the target cell is joint.

In some embodiments, the third indication information indicates more than one transmission configuration indication (TCI) states for the first bandwidth part (BWP) of the target cell, wherein the more than one transmission configuration indication (TCI) states are transmission configuration indication (TCI) states activated for the first bandwidth part (BWP) of the target cell; and a first transmission configuration indication (TCI) state in the more than one transmission configuration indication (TCI) states is the transmission configuration indication (TCI) state applied to the first bandwidth part (BWP) of the target cell.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the data reception apparatus 1300 may further include other components or modules, and reference may be made to related techniques for particulars of these components or modules.

Furthermore, for the sake of simplicity, connection relationships between the components or modules or signal profiles thereof are only illustrated in FIG. 13. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

It can be seen from the above embodiment that the terminal equipment is able to quickly use a suitable TCI state after cell switch based on the first indication information, the second indication information and the third indication information, thereby reducing handover interruption times.

### Embodiments of a Sixth Aspect

The embodiments of this disclosure provide a data reception apparatus. The apparatus may be, for example, a terminal equipment, or one or some components or assemblies configured in the terminal equipment. Contents in the embodiments identical to those in the embodiments of the first aspect shall not be described herein any further.

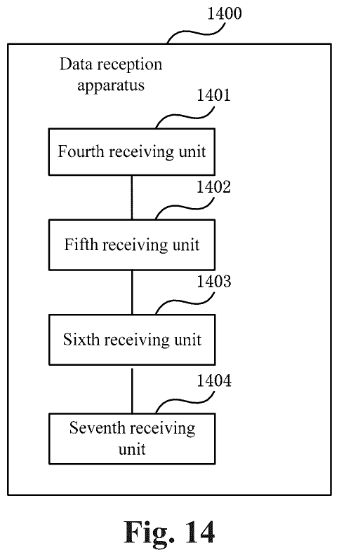

FIG. 14 is a schematic diagram of the data reception apparatus of the embodiments of this disclosure. As shown in FIG. 14, a data reception apparatus 1400 includes:
a fourth receiving unit 1401 configured to receive fourth indication information, the fourth indication information indicating at least one transmission configuration indication (TCI) state set;
a fifth receiving unit 1402 configured to receive fifth indication information, the fifth indication information indicating at least one transmission configuration indication (TCI) state subset, wherein for a transmission configuration indication (TCI) state set, the fifth indication information indicates a transmission configuration indication (TCI) state subset in the transmission configuration indication (TCI) state set;
a sixth receiving unit 1403 configured to receive sixth indication information, the sixth indication information indicating that the terminal equipment is switched to at least one target cell, wherein a target cell is one of candidate cells configured for the terminal equipment; and
a seventh receiving unit 1404 configured to receive seventh indication information, wherein for a target cell, the seventh indication information indicates a transmission configuration indication (TCI) state from a second transmission configuration indication (TCI) state set that is applied to a third bandwidth part (BWP) of the target cell, and wherein the second transmission configuration indication (TCI) state set is one of the transmission configuration indication (TCI) state subset indicated by the fifth indication information.

In some embodiments, in a case where the TCI state subset indicated by the fifth indication information for a BWP of the target cell includes a TCI state, the TCI state is the TCI state applied to the BWP of the target cell.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the data reception apparatus 1400 may further include other components or modules, and reference may be made to related techniques for particulars of these components or modules.

Furthermore, for the sake of simplicity, connection relationships between the components or modules or signal profiles thereof are only illustrated in FIG. 14. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

It can be seen from the above embodiment that the terminal equipment is able to quickly use

a suitable TCI state after cell switch based on the fourth indication information, the fifth indication information, the sixth indication information and the seventh indication information, thereby reducing handover interruption times.

### Embodiments of a Seventh Aspect

The embodiments of this disclosure provide a data transmission apparatus. The apparatus may be, for example, a network device, or one or some components or assemblies configured in the network device. Contents in the embodiments identical to those in the embodiments of the third aspect shall not be described herein any further.

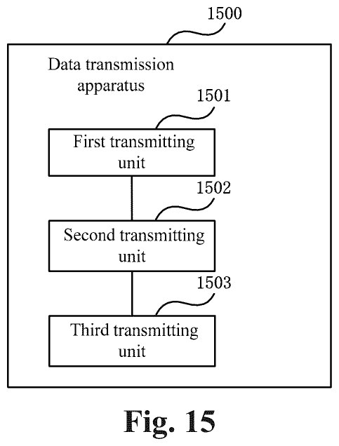

FIG. 15 is a schematic diagram of the data transmission apparatus of the embodiments of this disclosure. As shown in FIG. 15, a data transmission apparatus 1500 includes:
a first transmitting unit 1501 configured to transmit first indication information, the first indication information indicating at least one transmission configuration indication (TCI) state set;
a second transmitting unit 1502 configured to transmit second indication information, the second indication information indicating that a terminal equipment is switched to at least one target cell; and
a third transmitting unit 150 configured to transmit third indication information, wherein for a target cell, the third indication information indicates a transmission configuration indication (TCI) state that is applied to a first bandwidth part (BWP) of the target cell from a first transmission configuration indication (TCI) state set, and wherein the first transmission configuration indication (TCI) state set is one of the transmission configuration indication (TCI) state set indicated by the first indication information.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the data transmission apparatus 1500 may further include other components or modules, and reference may be made to related techniques for particulars of these components or modules.

Furthermore, for the sake of simplicity, connection relationships between the components or modules or signal profiles thereof are only illustrated in FIG. 15. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

It can be seen from the above embodiment that the terminal equipment is able to quickly use a suitable TCI state after cell switch based on the first indication information, the second indication information and the third indication information, thereby reducing handover interruption times.

### Embodiments of an Eighth Aspect

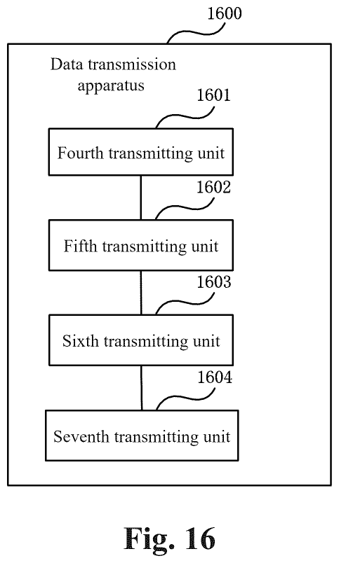

The embodiments of this disclosure provide a data transmission apparatus. The apparatus may be, for example, a network device, or one or some components or assemblies configured in the network device. Contents in the embodiments identical to those in the embodiments of the fourth aspect shall not be described herein any further. FIG. 16 is a schematic diagram of the data transmission apparatus of the embodiments of this disclosure. As shown in FIG. 16, a data transmission apparatus 1600 includes:
a fourth transmitting unit 1601 configured to transmit fourth indication information, the fourth indication information indicating at least one transmission configuration indication (TCI) state set;
a fifth transmitting unit 1602 configured to transmit fifth indication information, the fifth indication information indicating at least one transmission configuration indication (TCI) state subset, wherein for a transmission configuration indication (TCI) state set, the fifth indication information indicates a transmission configuration indication (TCI) state subset in the transmission configuration indication (TCI) state set;
a sixth transmitting unit 1603 configured to transmit sixth indication information, the sixth indication information indicating that a terminal equipment is switched to at least one target cell, wherein a target cell is one of candidate cells configured for the terminal equipment; and
a seventh transmitting unit 1604 configured to transmit seventh indication information, wherein for a target cell, the seventh indication information indicates a transmission configuration indication (TCI) state from a second transmission configuration indication (TCI) state set that is applied to a third bandwidth part (BWP) of the target cell, and wherein the second transmission configuration indication (TCI) state set is one of the transmission configuration indication (TCI) state subset indicated by the fifth indication information.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the data transmission apparatus 1600 may further include other components or modules, and reference may be made to related techniques for particulars of these components or modules.

Furthermore, for the sake of simplicity, connection relationships between the components or modules or signal profiles thereof are only illustrated in FIG. 16. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

It can be seen from the above embodiment that the terminal equipment is able to quickly use a suitable TCI state after cell switch based on the fourth indication information, the fifth indication information, the sixth indication information and the seventh indication information, thereby reducing handover interruption times.

### Embodiments of a Ninth Aspect

The embodiments of this disclosure provide a communication system, and reference may be made to FIG. 1, with contents identical to those in the embodiments of the first to the eighth aspects being not going to be described herein any further.

In some embodiments, the communication system 100 may at least include:
a terminal equipment configured to receive first indication information, the first indication information indicating at least one transmission configuration indication (TCI) state set; receive second indication information, the second indication information indicating that the terminal equipment is switched to at least one target cell; and receive third indication information, wherein for a target cell, the third indication information indicates a transmission configuration indication (TCI) state that is applied to a first bandwidth part (BWP) of the target cell from a first transmission configuration indication (TCI) state set, and wherein the first transmission configuration indication (TCI) state set is one of the transmission configuration indication (TCI) state set indicated by the first indication information; and
a network device configured to transmit the first indication information, the second indication information and the third indication information.

In some embodiments, the communication system 100 may at least include:
a terminal equipment configured to receive fourth indication information, the fourth indication information indicating at least one transmission configuration indication (TCI) state set; receive fifth indication information, the fifth indication information indicating at least one transmission configuration indication (TCI) state subset, wherein for a transmission configuration indication (TCI) state set, the fifth indication information indicates a transmission configuration indication (TCI) state subset in the transmission configuration indication (TCI) state set; receive sixth indication information, the sixth indication information indicating that the terminal equipment is switched to at least one target cell, wherein a target cell is one of candidate cells configured for the terminal equipment; and receive seventh indication information, wherein for a target cell, the seventh indication information indicates a transmission configuration indication (TCI) state from a second transmission configuration indication (TCI) state set that is applied to a third bandwidth part (BWP) of the target cell, and wherein the second transmission configuration indication (TCI) state set is one of the transmission configuration indication (TCI) state subset indicated by the fifth indication information; and
a network device configured to transmit the fourth indication information, the fifth indication information, the sixth indication information and the seventh indication information.

The embodiments of this disclosure further provides a network device, which may be, for example, a base station. However, this disclosure is not limited thereto, and it may also be another network device.

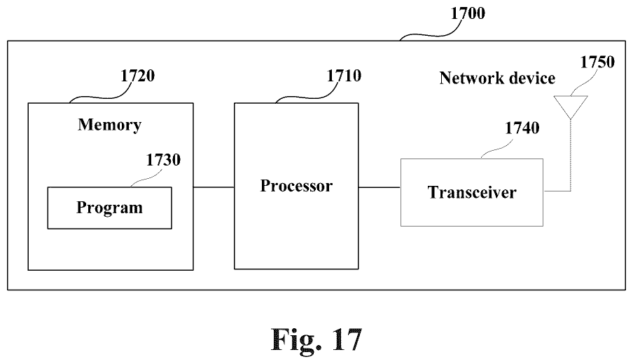

FIG. 17 is a schematic diagram of a structure of the network device of the embodiments of this disclosure. As shown in FIG. 17, a network device 1700 may include a processor 1710 (such as a central processing unit (CPU)) and a memory 1720, the memory 1720 being coupled to the processor 1710. The memory 1720 may store various data, and furthermore, it may store a program 1730 for information processing, and execute the program 1730 under control of the processor 1710.

Furthermore, as shown in FIG. 17, the network device 1700 may include a transceiver 1740, and an antenna 1750, etc. Functions of the above components are similar to those in the related art, and shall not be described herein any further. It should be noted that the network device 1700 does not necessarily include all the parts shown in FIG. 17, and furthermore, the network device 1700 may include parts not shown in FIG. 17, and the related art may be referred to.

The embodiments of this disclosure further provides a terminal equipment; however, this disclosure is not limited thereto, and it may also be another equipment.

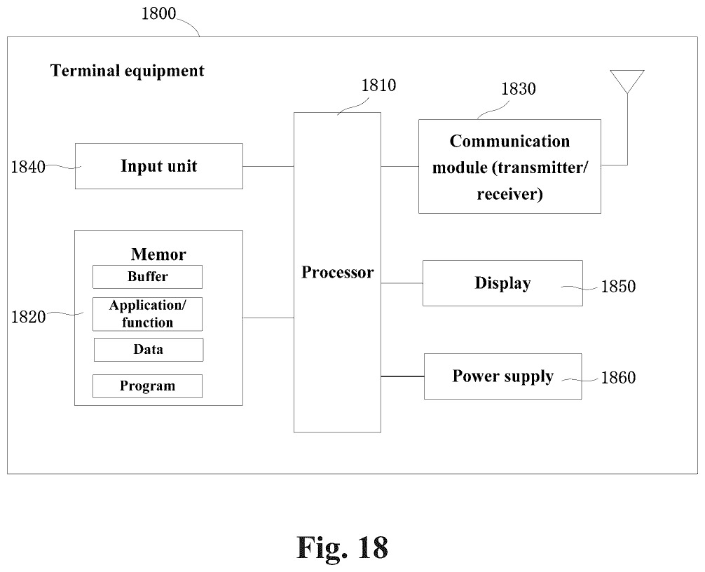

FIG. 18 is a schematic diagram of the terminal equipment of the embodiments of this disclosure. As shown in FIG. 18, a terminal equipment 1800 may include a processor 1810 and a memory 1820, the memory 1820 storing data and a program and being coupled to the processor 1810. It should be noted that this figure is illustrative only, and other types of structures may also be used, so as to supplement or replace this structure and achieve a telecommunications function or other functions.

For example, the processor 1810 may be configured to execute a program to carry out the data reception method as described in the embodiments of the first aspect. For example, the processor 1810 may be configured to execute the following control: receiving first indication information, the first indication information indicating at least one transmission configuration indication (TCI) state set; receiving second indication information, the second indication information indicating that the terminal equipment is switched to at least one target cell; and receiving third indication information, wherein for a target cell, the third indication information indicates a TCI state that is applied to a first BWP of the target cell from a first TCI state set, and wherein the first TCI state set is one of the TCI state set indicated by the first indication information. Or, the processor 1810 may be configured to execute the following control: receiving fourth indication information, the fourth indication information indicating at least one TCI state set; receiving fifth indication information, the fifth indication information indicating at least one TCI state subset, wherein for a TCI state set, the fifth indication information indicates a TCI state subset in the TCI state set; receiving sixth indication information, the sixth indication information indicating that the terminal equipment is switched to at least one target cell, wherein a target cell is one of candidate cells configured for the terminal equipment; and receiving seventh indication information, wherein for a target cell, the seventh indication information indicates a TCI state from a second TCI state set that is applied to a third BWP of the target cell, and wherein the second TCI state set is one of the TCI state subset indicated by the fifth indication information.

As shown in FIG. 18, the terminal equipment 1800 may further include a communication module 1830, an input unit 1840, a display 1850, and a power supply 1860, wherein functions of the above components are similar to those in the related art, which shall not be described herein any further. It should be noted that the terminal equipment 1800 does not necessarily include all the parts shown in FIG. 18, and the above components are not necessary. Furthermore, the terminal equipment 1800 may include parts not shown in FIG. 18, and the related art may be referred to.

Embodiments of this disclosure provide a computer program, which, when executed in a terminal equipment, will cause the terminal equipment to carry out the data reception methods as described in the embodiments of the first and second aspects.

Embodiments of this disclosure provides a computer medium, including a computer program, which will cause a terminal equipment to carry out the data reception methods as described in the embodiments of the first and second aspects.

Embodiments of this disclosure provides a computer program, which, when executed in a network device, will cause the network device to carry out the data transmission methods as described in the embodiments of the third and fourth aspects.

Embodiments of this disclosure provides a computer medium, including a computer program, which will cause a network device to carry out the data transmission methods as described in the embodiments of the third and fourth aspects.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, an EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

As to implementations containing the above embodiments, following supplements are further disclosed.
1. A data reception method, applicable to a terminal equipment, the data reception method including:
receiving first indication information, the first indication information indicating at least one TCI state set;
receiving second indication information, the second indication information indicating that the terminal equipment is switched to at least one target cell; and receiving third indication information, wherein for a target cell, the third indication information indicates a TCI state that is applied to a first bandwidth part (BWP) of the target cell from a first TCI state set, and wherein the first TCI state set is one of the TCI state set indicated by the first indication information.
2. The method according to supplement 1, wherein the target cell is one of at least one candidate cell configured for the terminal equipment,
the at least one candidate cell including a serving cell and/or a non-serving cell.
3. The method according to supplement 1, wherein the first indication information indicating at least one TCI state set includes at least one of the following:
the first indication information indicating a TCI state set for the terminal equipment;
for a serving cell, the first indication information indicating a TCI state set for a bandwidth part (BWP) of the serving cell; or
for a candidate cell, the first indication information indicating a TCI state set for a bandwidth part (BWP) of the candidate cell.
4. The method according to supplement 3, wherein in a case where the first indication information indicates a TCI state set for a BWP of the serving cell,
in a case where a unified TCI state type (unifiedTCI-StateType) configured for at least one candidate cell is separate,
the first indication information indicates a downlink or joint TCI state set for a downlink bandwidth part (BWP) of a first serving cell, and indicates an uplink TCI state set for an uplink bandwidth part (BWP) of a second serving cell, wherein the first serving cell is identical to or different from the second serving cell.
5. The method according to supplement 3, wherein in a case where the first indication information indicates a TCI state set for the terminal equipment,
in a case where a unified TCI state type (unifiedTCI-StateType) configured for at least one candidate cell is separate,
the first indication information indicates a downlink or joint TCI state set for the terminal equipment, and indicates an uplink TCI state set for the terminal equipment.
6. The method according to supplement 3, wherein in the case where the first indication information indicates a TCI state set for the terminal equipment, or in the case where the first indication information indicates a TCI state set for a BWP of the serving cell,
the TCI state set includes at least one first TCI state and at least one second TCI state, or the TCI state set includes at least one second TCI state,
wherein the first TCI state is applicable to the BWP of the serving cell, and the second TCI state is applicable to the BWP of the candidate cell.
7. The method according to supplement 6, wherein the TCI state set is indicated in serving cell configuration information.
8. The method according to supplement 3, wherein in the case where the first indication information indicates a TCI state set for a BWP of the candidate cell,
the TCI state set includes at least one third TCI state, wherein the third TCI state is applied to the BWP of the candidate cell.
9. The method according to supplement 8, wherein the TCI state set is indicated in candidate cell configuration information.
10. The method according to supplement 3, wherein in the case where the first indication information indicates a TCI state set for the terminal equipment,
the first TCI state set is the TCI state set that is indicated.
11. The method according to supplement 3, wherein in the case where the first indication information indicates a TCI state set for a BWP of the serving cell,
the first indication information indicates a TCI state set for a BWP of a serving cell, the first TCI state set being the TCI state set that is indicated.
12. The method according to supplement 3, wherein in the case where the first indication information indicates a TCI state set for a BWP of the serving cell,
the second indication information further indicates a serving cell and a BWP of the serving cell,
wherein the first TCI state set is the TCI state set indicated by the second indication information for the BWP of the serving cell.
13. The method according to supplement 3, wherein in the case where the first indication information indicates a TCI state set for a BWP of the candidate cell,
for a target cell, the first TCI state set is the TCI state set indicated for the first BWP of the target cell.
14. The method according to supplement 1, wherein the target cell is indicated by the second indication information, or is determined according to a reference signal in the TCI state indicated by the third indication information.
15. The method according to supplement 1, wherein the first BWP of the target cell is indicated by the second indication information, or is determined according to candidate cell configuration information.
16. The method according to supplement 1, wherein the method further includes:
applying the TCI state indicated by the third indication information on a second BWP of a second target cell by the terminal equipment, wherein the second target cell is in the same TCI state update list as the target cell, and BWP IDs of the second BWP and the first BWP are identical.
17. The method according to supplement 1, wherein the method further includes:
in a case where the unified TCI state type (unifiedTCI-StateType) configured for the target cell is joint, applying the TCI state indicated by the third indication information on a downlink BWP and an uplink BWP of the target cell by the terminal equipment.
18. The method according to supplement 1, wherein the method further includes:
indicating more than one TCI states by the third indication information for the first BWP of the target cell, wherein the more than one TCI states are TCI states activated for the first BWP of the target cell,
and a first TCI state in the multiple TCI states is the TCI state applied to the first BWP of the target cell.
19. The method according to supplement 1, wherein the first indication information is carried by RRC signaling, and/or, the second indication information is carried by an MAC CE, and/or, the third indication information is carried by an MAC CE or DCI.
20. The method according to supplement 19, wherein the second indication information and the third indication information are carried by one MAC CE; or,
the second indication information is carried by an MAC CE, the third indication information is carried by another MAC CE, and the MAC CE carrying the second indication information and the MAC CE carrying the third indication information are carried by a PDSCH; or,
the second indication information is carried by an MAC CE, the third indication information is carried by DCI and at least one MAC CE, and the MAC CE carrying the second indication information and the MAC CE carrying the third indication information are carried by a PDSCH scheduled by the DCI.
21. The method according to any one of supplements 1-20, wherein the TCI state is indicated by a TCI state identifier or a TCI state index.
22. The method according to any one of supplements 1-21, wherein the TCI state set is a downlink or joint TCI state set, the TCI state is a downlink or joint TCI state, and the BWP is a downlink BWP; or, the TCI state set is an uplink TCI state set, the TCI state is an uplink TCI state, and the BWP is an uplink BWP.
23. A data reception method, applicable to a terminal equipment, the data reception method including:
receiving fourth indication information, the fourth indication information indicating at least one TCI state set;
receiving fifth indication information, the fifth indication information indicating at least one TCI state subset, wherein for a TCI state set, the fifth indication information indicates a TCI state subset in the TCI state set;
receiving sixth indication information, the sixth indication information indicating that the terminal equipment is switched to at least one target cell, wherein a target cell is one of candidate cells configured for the terminal equipment; and
receiving seventh indication information, wherein for a target cell, the seventh indication information indicates a TCI state from a second TCI state set that is applied to a third BWP of the target cell, and wherein the second TCI state set is one of the TCI state subset indicated by the fifth indication information.
24. The method according to supplement 23, wherein the method further includes:
in a case where the TCI state subset indicated by the fifth indication information for a BWP of the target cell includes a TCI state, the TCI state is the TCI state applied to the BWP of the target cell.
25. A data transmission method, applicable to a network device, the method including:
transmitting first indication information, the first indication information indicating at least one TCI state set;
transmitting second indication information, the second indication information indicating that a terminal equipment is switched to at least one target cell; and
transmitting third indication information, wherein for a target cell, the third indication information indicates a TCI state that is applied to a first BWP of the target cell from a first TCI state set, and wherein the first TCI state set is one of the TCI state set indicated by the first indication information.
26. A data transmission method, applicable to a network device, the method including:
transmitting fourth indication information, the fourth indication information indicating at least one TCI state set;
transmitting fifth indication information, the fifth indication information indicating at least one TCI state subset, wherein for a TCI state set, the fifth indication information indicates a TCI state subset in the TCI state set;
transmitting sixth indication information, the sixth indication information indicating that a terminal equipment is switched to at least one target cell, wherein a target cell is one of candidate cells configured for the terminal equipment; and
transmitting seventh indication information, wherein for a target cell, the seventh indication information indicates a TCI state from a second TCI state set that is applied to a third BWP of the target cell, and wherein the TCI state set is one of the TCI state subset indicated by the fifth indication information.
27. A terminal equipment, including a memory and a processor, the memory storing a computer program, and the processor being configured to execute the computer program to carry out the data reception method as described in any one of supplements 1-24.
28. A network device, including a memory and a processor, the memory storing a computer program, and the processor being configured to execute the computer program to carry out the data transmission method as described in either one of supplements 25-26.
29. A communication system, including:
a terminal equipment configured to receive first indication information, the first indication information indicating at least one transmission configuration indication (TCI) state set; receive second indication information, the second indication information indicating that the terminal equipment is switched to at least one target cell; and receive third indication information, wherein for a target cell, the third indication information indicates a transmission configuration indication (TCI) state that is applied to a first bandwidth part (BWP) of the target cell from a first transmission configuration indication (TCI) state set, and wherein the first transmission configuration indication (TCI) state set is one of the transmission configuration indication (TCI) state set indicated by the first indication information; and
a network device configured to transmit the first indication information, the second indication information and the third indication information.
30. A communication system, including:
a terminal equipment configured to receive fourth indication information, the fourth indication information indicating at least one transmission configuration indication (TCI) state set; receive fifth indication information, the fifth indication information indicating at least one transmission configuration indication (TCI) state subset, wherein for a transmission configuration indication (TCI) state set, the fifth indication information indicates a transmission configuration indication (TCI) state subset in the transmission configuration indication (TCI) state set; receive sixth indication information, the sixth indication information indicating that the terminal equipment is switched to at least one target cell, wherein a target cell is one of candidate cells configured for the terminal equipment; and receive seventh indication information, wherein for a target cell, the seventh indication information indicates a transmission configuration indication (TCI) state from a second transmission configuration indication (TCI) state set that is applied to a third bandwidth part (BWP) of the target cell, and wherein the second transmission configuration indication (TCI) state set is one of the transmission configuration indication (TCI) state subset indicated by the fifth indication information; and
a network device configured to transmit the fourth indication information, the fifth indication information, the sixth indication information and the seventh indication information.

1. A data reception apparatus, configured in a terminal equipment, the data reception apparatus comprising:
a receiver configured to:
receive first indication information, the first indication information indicating a transmission configuration indication (TCI) state set for each candidate cell and including information of a unified TCI state type (unified TCI-StateType) for each candidate cell,
receive second indication information, the second indication information indicating that the terminal equipment is switched to a target cell which is one of at least one candidate cell configured for the terminal equipment, and
receive third indication information, the third indication information indicating a transmission configuration indication (TCI) state that is applied to a first bandwidth part (BWP) of the target cell from the transmission configuration indication (TCI) state set of the target cell and
processor circuitry configured to perform a process to switch to the target cell according to the second indication information.

2. The apparatus according to claim 1, wherein the at least one candidate cell including the target cell comprises a serving cell and/or a non-serving cell.

3. The apparatus according to claim 1, wherein the TCI state set is for a bandwidth part (BWP) of the candidate cell.

4. The apparatus according to claim 3, wherein the TCI state set comprises a first TCI state, wherein the first TCI state is applied to the BWP of the candidate cell.

5. The apparatus according to claim 3, wherein the TCI state set is indicated in candidate cell configuration information.

6. The apparatus according to claim 3, wherein the TCI state set is indicated for the first BWP of the target cell.

7. The apparatus according to claim 1, wherein the target cell is indicated by the second indication information.

8. The apparatus according to claim 1, wherein the first BWP of the target cell is indicated by the second indication information or is determined according to candidate cell configuration information.

9. The apparatus according to claim 1, wherein the processor circuitry is further configured to apply the TCI state indicated by the third indication information to a downlink bandwidth part (BWP) and an uplink bandwidth part (BWP) of the target cell when the unified TCI state type (unifiedTCI-State Type) configured for the target cell is joint.

10. The apparatus according to claim 1, wherein
the receiver is configured to receive a MAC (Media Access Control) CE (Control Element) including the second indication information and the third indication information.

11. A data reception apparatus, applicable to a terminal equipment, the data reception apparatus comprising:
a receiver configured to:
receive fourth indication information, the fourth indication information indicating a transmission configuration indication (TCI) state set for each candidate cell and including information of a unified TCI state type (unified TCI-StateType) for each candidate cell,
receive fifth indication information, the fifth indication information indicating a transmission configuration indication (TCI) state subset for a transmission configuration indication (TCI) state set, and
receive sixth indication information, the sixth indication information indicating that the terminal equipment is switched to a target cell which is one of at least one candidate cell configured for the terminal equipment, and
receive seventh indication information, the seventh indication information indicates a transmission configuration indication (TCI) state from a second transmission configuration indication (TCI) state set that is applied to a third bandwidth part (BWP) of the target cell, and wherein the second transmission configuration indication (TCI) state set is the transmission configuration indication (TCI) state subset of the target cell; and
processor circuitry configured to perform a process to switch to the target cell according to the sixth indication information.

12. A data transmission apparatus, configured in a network device, the data transmission apparatus comprising:
a transmitter configured to transmit first indication information to a terminal equipment, the first indication information indicating a transmission configuration indication (TCI) state set for each candidate cell and including information of a unified TCI state type (unified TCI-State Type) for each candidate cell, and
processor circuitry configured to control to cause the terminal equipment to perform a process to switch to a target cell by transmitting second indication information, the second indication information indicating that the terminal equipment is switched to the target cell which is one of at least one candidate cell configured for the terminal equipment, wherein
the transmitter is configured to transmit third indication information, the third indication information indicating a transmission configuration indication (TCI) state that is applied to a first bandwidth part (BWP) of the target cell from the transmission configuration indication (TCI) state set of the target cell.

13. The apparatus according to claim 12, wherein
the transmitter is configured to transmit a MAC (Media Access Control) CE (Control Element) including the second indication information and the third indication information.
